(19) United States
(12) Patent Application Publication
(10) Pub. No.: US 2023/0331534 A1
(43) Pub. Date: Oct. 19, 2023

(54) SYRUP AND SAUCE DISPENSING SYSTEM

(71) Applicants: GILLIAN CALLAGHAN, Vero Beach, FL (US); John Newton, Bebastian, FL (US); Jacob Lockwood, Vero Beach, FL (US); Michael Cheney, Vero Beach, FL (US); Dustin Hartsfield, Sebastian, FL (US); Rory Pawl, Vero Beach, FL (US); Benjamin Piper, Elk Grove, CA (US)

(72) Inventors: GILLIAN CALLAGHAN, Vero Beach, FL (US); John Newton, Bebastian, FL (US); Jacob Lockwood, Vero Beach, FL (US); Michael Cheney, Vero Beach, FL (US); Dustin Hartsfield, Sebastian, FL (US); Rory Pawl, Vero Beach, FL (US); Benjamin Piper, Elk Grove, CA (US)

(73) Assignee: GATE CFV SOLUTIONS, INC., Sebastian, FL (US)

(21) Appl. No.: 18/140,172

(22) Filed: Apr. 27, 2023

Related U.S. Application Data
(63) Continuation-in-part of application No. 18/115,258, filed on Feb. 28, 2023.
(60) Provisional application No. 63/335,858, filed on Apr. 28, 2022.
(60) Provisional application No. 63/315,191, filed on Mar. 1, 2022.

(51) Int. Cl. B67D 1/04; B67D 1/08; B67D 1/12; B67D 1/07; B67D 1/00

(52) U.S. Cl. CPC B67D 1/04; B67D 1/0884; B67D 1/125; B67D 1/07; B67D 1/0015; B67D 2001/0098

(57) ABSTRACT

A dispensing system including: a pressure vessel with an inlet and an outlet; a first CF Valve coupled to the inlet; a second CF Valve coupled to the outlet; a bag with elements in the bag coupled to the outlet and located inside the pressure vessel; and a pressure source coupled to the first CF Valve where the first CF Valve pressurizes the pressure vessel via the pressure source to transport elements in the bag to the second CF Valve via the outlet and the second CF Valve dispenses the elements to a dispensing area.

### REFERENCE TO RELATED APPLICATION

The present application is a continuation-in-part and claims priority to U.S. patent application Ser. No. 18/115,258 entitled “Pressurized Dispensing System” filed on Feb. 28, 2023 and Provisional Patent Application Ser. No. 63/335,858 filed on Apr. 28, 2022. U.S. patent application Ser. No. 18/115,258 claims priority to Provisional Patent Application No. 63/315,191 filed on Mar. 1, 2022, which are all incorporated in their entireties by reference.

### BACKGROUND DISCUSSION

The dispensing industry is becoming more complex based on customer demand for customized drinks. These customized drinks require precision applications of various liquids and gases. In addition, material cost, labor cost, and labor safety are important factors that need to be enhanced. By utilizing this disclosure, the operator can achieve customized, precision drinks with reduced material cost and labor cost while increase labor safety.

### FIELD OF THE DISCLOSURE

This disclosure relates generally to liquid and/or gas delivery systems, and is concerned in particular with a system capable of delivering an on-demand customized mixture. Further, this disclosure illustrates a cleaning (e.g., cleaning, sanitizing, and/or rinsing) system for a drink dispensing device.

### SUMMARY OF THE DISCLOSURE

In accordance with one aspect of the present disclosure, a liquid dispensing system comprises one or more pressurized containers. A flexible bag in the pressurized container contains a first liquid. A supply source introduces a pressurized liquid (and/or a pressurized gas) into the chamber. The pressurized liquid (and/or a pressurized gas) moves the first liquid from the flexible bag to an outlet area. The supply source of the liquid dispenser system may include a constant flow valve located externally of the pressurized container. A constant flow valve may be located on the incoming pressure source and/or the constant flow valve may be located on the outlet for the liquid.

### BRIEF DESCRIPTION OF THE DRAWINGS

FIGS. 1A-1D are illustrations of an exemplary embodiment of a liquid delivery system, according to one embodiment;

FIGS. 2A-2I are illustrations depicting various lid and/or door devices, according to various embodiments;

FIGS. 3A-3D are illustrations of CF Valves being utilized before and/or after the pressurized container containing a bag, according to various embodiments;

FIG. 3E is an illustration of a CF Valve, according to one embodiment;

FIG. 3F is an illustration of a CF Valve without a throttle pin, according to one embodiment;

FIGS. 4A-4B are illustrations of CF Valves being utilized after the pressurized container containing a bag, according to various embodiments;

FIGS. 4C-4F are illustrations of a fitting being utilized to connect the bag to the faucet, according to various embodiments;

FIGS. 4G-4H are illustrations of a cleaning system, according to various embodiments;

FIGS. 5A-5C are illustrations of a cleaning system, according to various embodiments;

FIGS. 6A-6E are illustrations of the pressurized container containing a bag, according to various embodiments;

FIGS. 7A-7D are illustrations of a customizable drink dispensing system, according to various embodiments;

FIG. 8 is an illustration of a bag, according to one embodiment;

FIGS. 9A-9B are illustrations of block diagrams, according to various embodiments;

FIGS. 10A-10C are illustrations of flowcharts, according to various embodiments;

FIGS. 11A-11D are illustrations of the utilization of a toggling device with the dispensing system, according to various embodiments;

FIGS. 12A-13B are illustrations of a blocking device and a movement device, according to various embodiments;

FIGS. 14A-15C are illustrations of the pressurized container dispensing system, according to various embodiments;

FIGS. 16A-16B are illustrations of the pressurized release devices, according to various embodiments;

FIGS. 16C-16D are illustrations of the customizable drink dispensing system, according to various embodiments;

FIGS. 17A-17B are illustrations of a cartridge, according to various embodiments;

FIG. 18 is an illustration of a flow rate control, according to one embodiment;

FIG. 19 shows an illustration of a lid with a CF Valve attached to the lid, according to one embodiment;

FIGS. 20-21 are illustrations of a CF Valve, according to various embodiments;

FIG. 22 is an illustration of a pressurized container, according to one embodiment;

FIG. 23 is an illustration of a pressurized container, according to one embodiment;

FIG. 24 is an illustration of a pressurized container, according to one embodiment;

FIG. 25 is an illustration of a pressurized container, according to one embodiment;

FIG. 26 is an illustration of a pressurized container, according to one embodiment;

FIG. 27 is an illustration of a pressurized container, according to one embodiment;

FIG. 28 is an illustration of a pressurized container, according to one embodiment; and

FIG. 29 is an illustration of a pressurized container, according to one embodiment.

### DETAILED DESCRIPTION

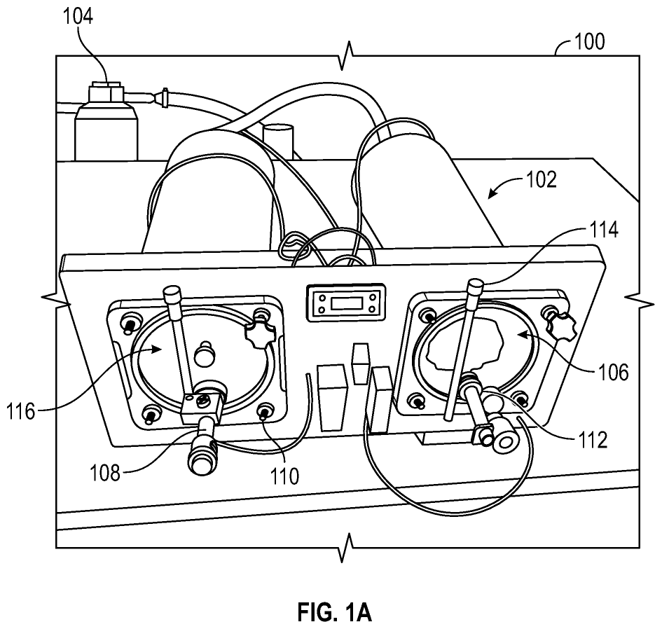

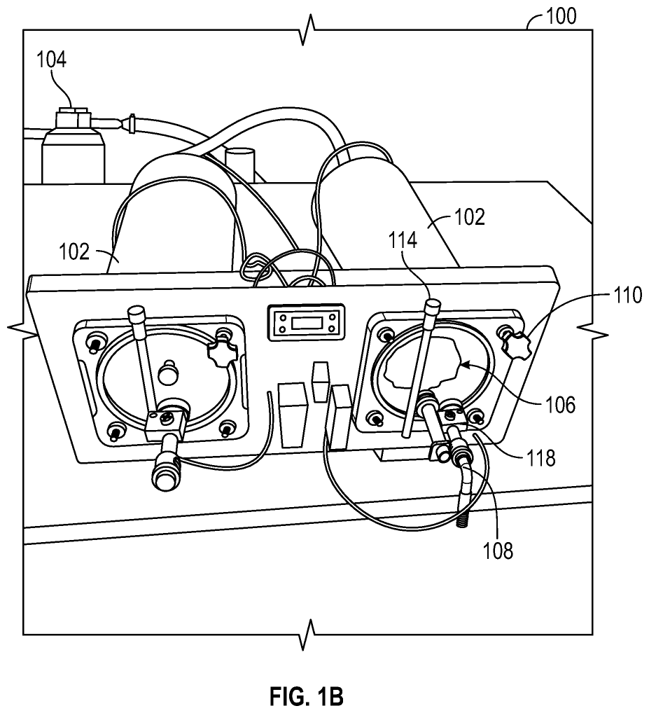

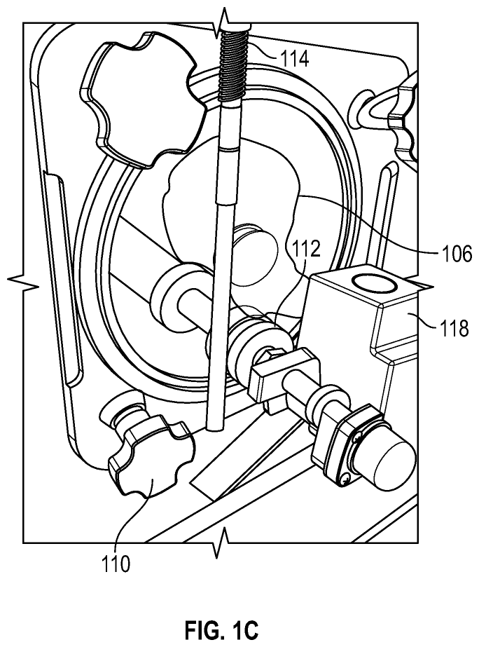

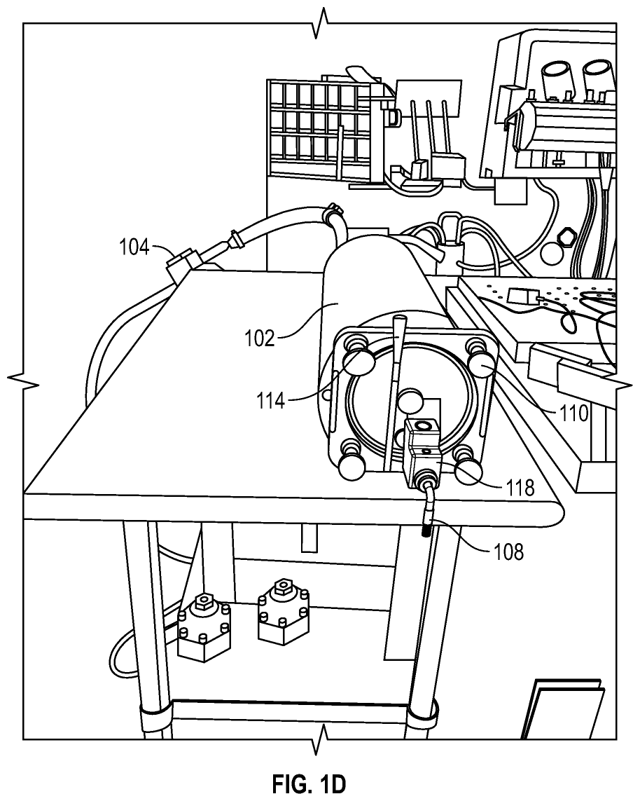

In FIGS. 1A-1D, illustrations of an exemplary embodiment of a liquid delivery system are shown, according to one embodiment. FIG. 1A shows a drink dispensing system 100, which includes one or more pressurized vessels 102, one or more control valves 104 located on the inlet side of the pressurized vessels 102, one or more bags 106 located inside of the one or more pressurized vessels 102, one or more control valves 108 located on the outlet side of the pressurized vessels 102, one or more removable covers 110 for the one or more pressurized vessels 102, one or more bulkheads 112, one or more pressure release devices 114, and/or one or more sliding trays 116.

In one example, the drink dispensing system 100 is a pressure dispensing system. The pressure dispensing system uses a pressure vessel 102 combined with an inbound pressure-controlled element (e.g., fluid, liquid, and/or gas) and one or more containers 106 located inside the pressure vessel 102 where the one or more containers 106 are filled with an ingredient connected to an outlet of the pressure vessel 102 to a point of mixing and/or dispensing. The outlet of the pressure vessel 102 can be controlled by mechanical and/or electronic device(s) 108 that can have flow control/portion control through the mechanical and/or electronic device(s) 108. In this example, the drink dispensing system 100 may be refillable through a removable lid/cover/access point 110.

In one example, the lid/cover/access point 110 may be removed for washing in a dishwasher or by hand. In addition, other automated clean in place methods can be applied. The lid/cover/access point 110 may be designed with a bulkhead 112 that connects the one or more containers 106 to the outlet device 108 that can withstand the pressure. In addition, a safety device 114 can be built into the lid/cover/access point 110 to ensure that all the pressure is released before the lid/cover/access point 110 is utilized. Further, the safety device 114 may have a pop-off feature if the pressure exceeds a target rate inside the pressure vessel 102.

FIG. 1A shows a first CF Valve with a first solenoid 104 controlling an input fluid (e.g., liquid or gas) into a pressure canister 102 with a flexible package 106 of a flavor fluid which connects to an outlet and flows through a second CF Valve with a second solenoid 108 to the point of dispensing. In one example, the pressure in can be from city water, an air compressor, a pump, a compressed gas (e.g., CO₂ and/or Nitrogen), and/or any other available pressure source. In this example, when the input fluid passes through the first CF Valve, the CF Valve creates a constant pressure into the pressure canister 102 of said input fluid (e.g., 7.5 PSI, 14 PSI, 21 PSI, 29 PSI, etc.) where that pressure will then act on the flexible package 106 which contains the flavor fluid (and/or flavor element and/or ingredients (e.g., sauce, catsup, and/or any ingredient used to make any beverage disclosed in this document) and the flavor fluid will be pushed through the flexible package 106 to the second CF Valve 108 (and/or outlet). Further, the second CF Valve 108 (and/or solenoid) when actuated (mechanically or via solenoid) will then allow the flow of the flavor fluid to the point of dispensing.

The benefits of the drink dispensing system 100 are that no pumps or plumbing or flow meters or connections are required to dispense any viscosity and/or any flow rate. In addition, there is minimal wetted surface for cleaning; there are minimal wetted surface and plumbing fixtures for the fluid to flow through. These assist system performance especially with very viscous materials that have a significant drop in pressure as they pass through the plumbing, pumps, flow meters, and/or connectors.

In another example, if the flavor fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of dispensing.

Further, if the flavor fluid is difficult to clean (e.g., viscosity, stickiness, dairy, etc.), there is a significant advantage to having the shortest possible wetted surface to facilitate cleaning.

FIG. 1B shows the drink dispensing system 100, which includes one or more pressurized vessels 102, one or more control valves 104 located on the inlet side of the pressurized vessels 102, one or more bags 106 located inside of the one or more pressurized vessels 102, one or more control valves 108 located on the outlet side of the pressurized vessels 102, one or more removable covers 110 for the one or more pressurized vessels 102, one or more bulkheads 112, one or more pressure release devices 114, and/or one or more sliding trays 116. In this example, an outlet CF Valve 118 is shown.

In one example, the sliding tray 116 can facilitate the placement of a new bag/container (e.g., one or more bags 106) of ingredients into the pressurized vessel 102. In this example, one or more ingredients and/or bags may be located within a pressurized vessel 102. In the case where a pressurized vessel 102 utilizes more than one ingredient, then the multiple ingredients can be designed to dispense individually, in combination, or both.

In one example, the drink dispensing system 100 can be combined with a user interface that connects with the point-of-sale, online ordering, and/or other processing systems to automatically dispense beverages either by the interaction with an employee, customer, server, or automatically when combined with a drive through style conveyor belt system. In addition, the drink dispensing system 100 may be completed automatically via any control signal. The system can be designed with the Internet of things connections for inventory control, sales data, usage data, etc. In addition, the drink dispensing system 100 can provide the employee/user with information on time—to sold out, temperature, usage, etc.

In another example, the system can utilize other methods to ensure proper dispense/portion control such as a temperature sensor that reads the temperature of the inbound syrup and based on the temperature of the syrup and the relative viscosity change at that temperature, the system will automatically adjust the dispense time to ensure the same volume is always dispensed. The system can incorporate a viscosity and/or dissolved solids meter(s) to measure variation in the ingredient(s) and similarly change the dispense time to ensure the same volume is dispensed.

FIG. 1C shows the drink dispensing system 100, which includes one or more bags 106 located inside of the one or more pressurized vessels 102, one or more removable covers 110 for the one or more pressurized vessels 102, one or more bulkheads 112, one or more pressure release devices 114, and/or the outlet CF Valve 118.

In one example, the pressure vessel can be a metal or plastic canister in any shape or a bottle (plastic or glass) or a bag that can withstand the targeted pressure of the system. In another example, the inbound pressure-controlled fluid can be any liquid or gas and is controlled by a CF Valve and/or pressure control device (e.g., a pressure regulating valve, a pump that delivers controlled pressure, and/or any other device that can keep a constant pressure into the pressure vessel). Further, the internal container can be a flexible package, a caulking gun type system, and/or any container that when the pressure acts on the container it pushes the ingredients out of the container. In another example, the outlet can be mechanically and/or electronically controlled and can be made of any material. Further, the outlet can be a faucet, a solenoid, an on/off valve, and/or a flow control device (e.g., CF Valve). In addition, the outlet can utilize electronics (e.g., time on, pulsing, flow meters, etc.) to control the volume/speed of dispense and/or it can utilize a fixed orifice (and/or orifices) to set the flow rates for each particular ingredient. In one example, the lid/cover/access point 110 can be Plexiglas, acrylic, plastic, and/or metal with a toggle, nut/screw, and/or any other method of fixing the lid/cover/access point to the pressure vessel 102 that can withstand the internal pressure. In another example, an automatic clean-in-place system can utilize a bag of cleaner and/or sanitizer to flush a portion of (and/or all) the drink dispensing system 100 and/or utilize the inlet pressure connection to injected diluted cleaner and/or sanitizer to flush the entire system and/or a portion thereof. In an example, the bulkhead 112 allows the syrup from the bag 106 to connect directly to the outlet of the system. Further, the bulkhead 112 can be incorporated into the lid/cover/access point 110 to facilitate cleaning and use or can be placed in another part of the system. In addition, the lid/cover/access point 110 and/or the bulkhead 112 are designed to seal and to not allow the pressure inside the vessel 102 to escape to atmosphere.

FIG. 1D shows the drink dispensing system 100, which includes one or more pressurized vessels 102, one or more control valves 104 located on the inlet side of the pressurized vessels 102, one or more control valves 108 located on the outlet side of the pressurized vessels 102, one or more removable covers 110 for the one or more pressurized vessels 102, one or more pressure release devices 114, and/or the outlet CF Valve 118.

In an example, there can be an automatic pressure release built into the lid/cover/access point 110 and/or canister to require the pressure to be released before removing the lid/cover 110. In one example, the natural pressure acting on the lid/cover 110 can create a seal which will not allow an opening function until the pressure is reduced. In another example, the sliding tray or other device such as a plastic sleeve can be incorporated to facilitate the placement and/or removal of the ingredient container 106 from inside the pressure vessel 102. In another example, more than one ingredient container can be placed inside a single pressure vessel 102 and can either dispense the ingredients individually, in combination, and/or both. For example, there could be a simple syrup, vanilla, strawberry, lime, chocolate where any one of these is dispensed either individually, in combination, and/or both. In another example, the drink dispensing system 100 can be completely or partially automated with a system that actuates the inlet pressure control valve and the outlet faucet/valve when called for by the user or automatically in the case of a conveyor belt system. In one example, if the inlet valve and the outlet valve are electronically controlled to open and close in concert (at the same time, or with slight variations in timing), the system can be programmed with recipes for different dispenses based on combinations and/or volumes of each ingredient. In another example, the connection of the cover/bulkhead to the lid to the bag/container is a quick connect which can be (or not be) a dry break that allows for the bag/container to connect to the bulkhead without dripping and/or reduced time/labor cost. In another example, the canister could be disposable and be a single use device. In another example, the drink dispensing system 100 may be an electric system and/or a non-electric system or a combination of both. The drink dispensing system 100 can utilize nitrogen (and/or air, and/or any other gas or liquid). In various examples, the drink dispensing system 100 may be pump and flow meter free. In other words, the drink dispensing system 100 may not utilize a pump and/or flow meter. In these examples, the CF Valve provides fixed pressure which runs the system. In various example, the only requirement for electricity is downstream of the system if there is a desire to have automation on the dispense, store recipes, and/or temperature adjusted dispense times for viscosity changes.

In one example, the CFive (e.g., CF Valve) controls the gas into the canister. In another example, there may be a safety feature that shuts off the nitrogen (and/or air, and/or any other gas and/or liquid) after the CFive mechanically (e.g., latch on lid can't be opened until ball valve closed) or electronically (e.g., power cut to CFive) fails. In another example, the tank is a standard KEG style canister with a modified cap. Further, the syrup is a bag-in-bottle device which is dripped into the canister (e.g., no syrup in canister, no cleaning or refilling is required) which is permanent to the equipment. In another example, the bag is pulled out and a new bag is attached and returned to the KEG (with or without a quick connect/bib type dry break). In one example, the cap is O-ring sealed to hold pressure where the action of releasing the latch will also allow a small amount of air to vent to depressurize before the full cap opens. In addition, the venting can be the same design as a KEG vent currently or combined with the lever action. In another example, the BIB bag has a connector that is a dry break that connects the bag to the tubing that goes through the canister to the outside (can be through a standard KEG fitting). In another example, the CFiVe (electric version—with solenoid) or CFiVe (plugged non-electric version without solenoid) may be downstream of the controls that dispense the pressure of the CFiVe is X PSI (needs to be enough to make the viscous syrup move quickly—and XX psi lower than the CF Valve). For example, the electric system has a CFiVe programmed for a touch screen for recipes and/or into the point-of-sales device for dispense. In addition, a temperature sensor can be added to allow for modifications in pour time for temperature and/or humidity sensitive viscosity. For example, the non-electric system may dispense mechanically via a tap or toggle or push-button type approach. In another example, orifice may be utilized to avoid high velocity events upon refilling the tank. In another example, a container/KEG for higher volume syrups and smaller bag and container/KEG for lower volume syrups may be employed.

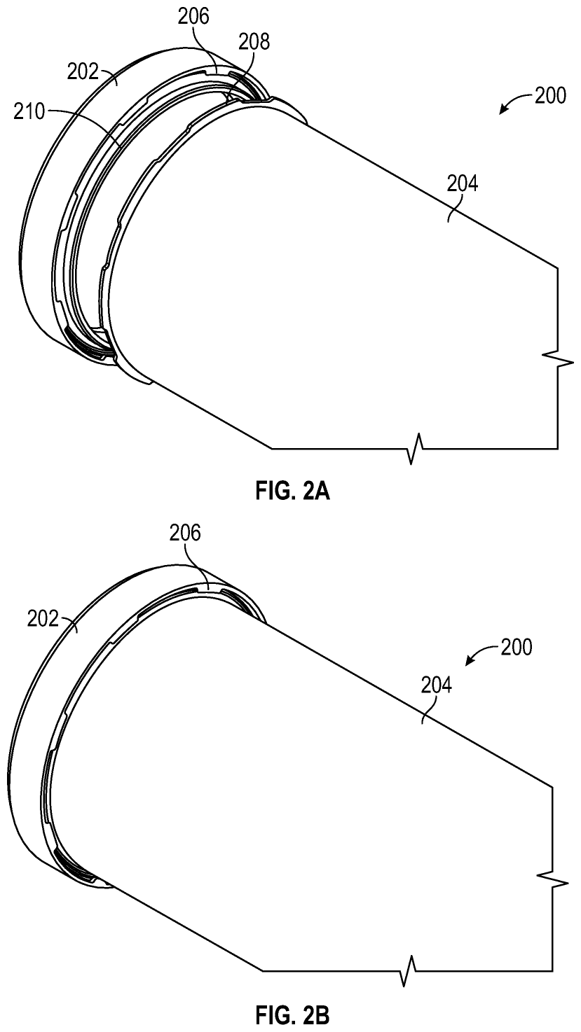

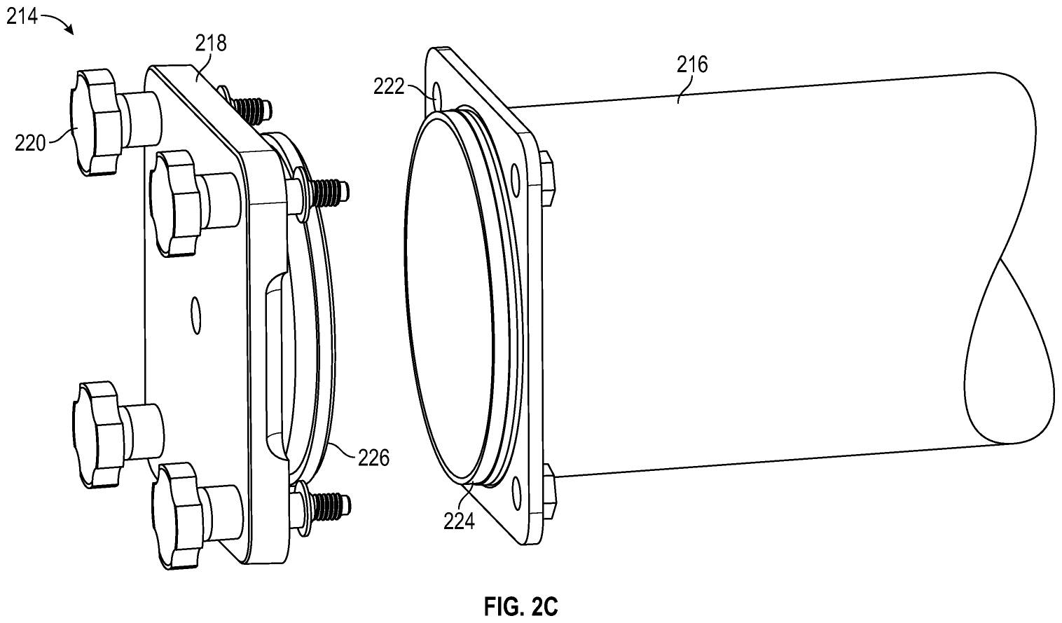

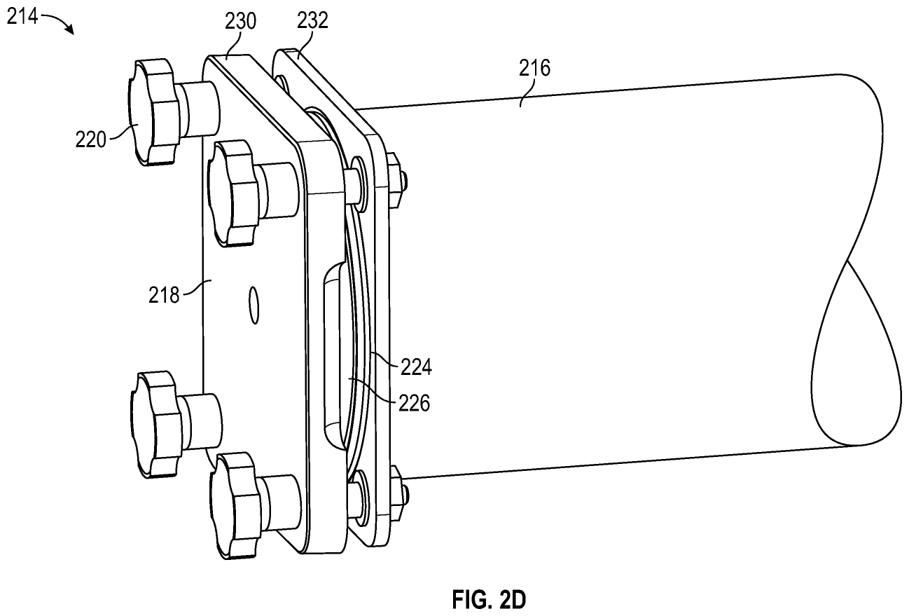

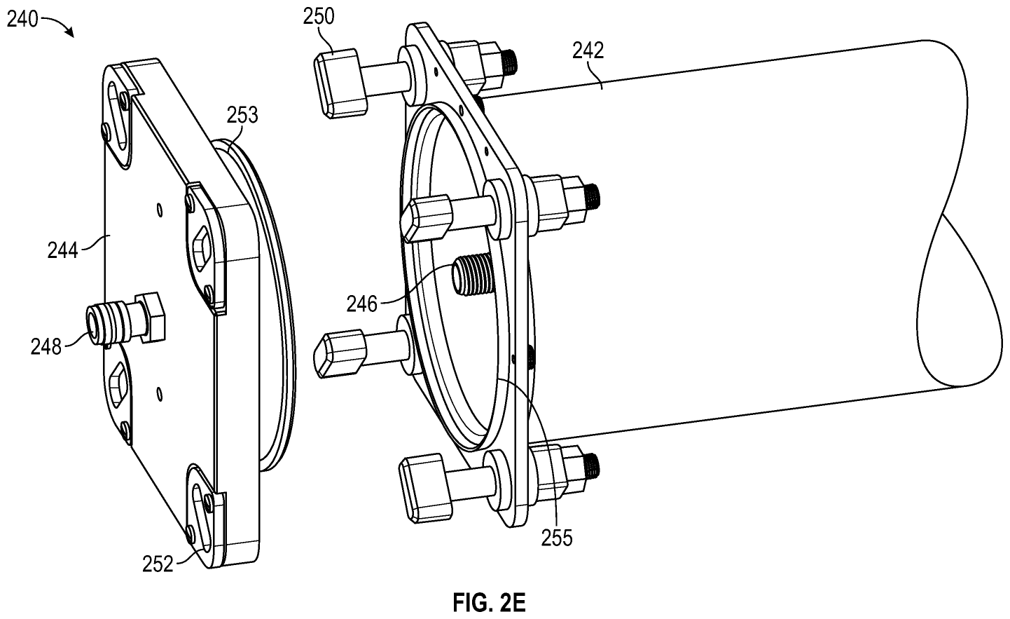

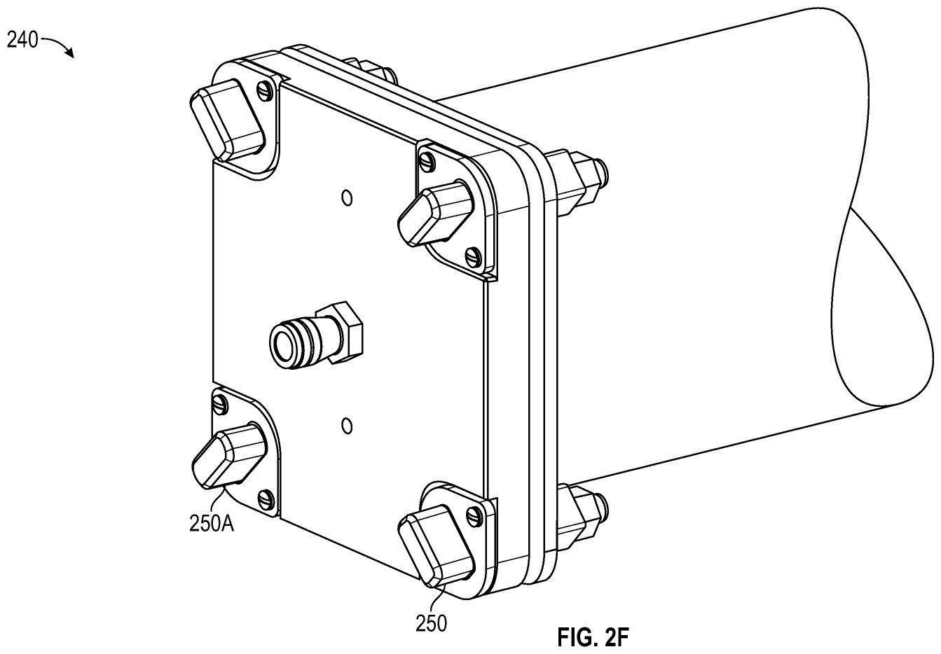

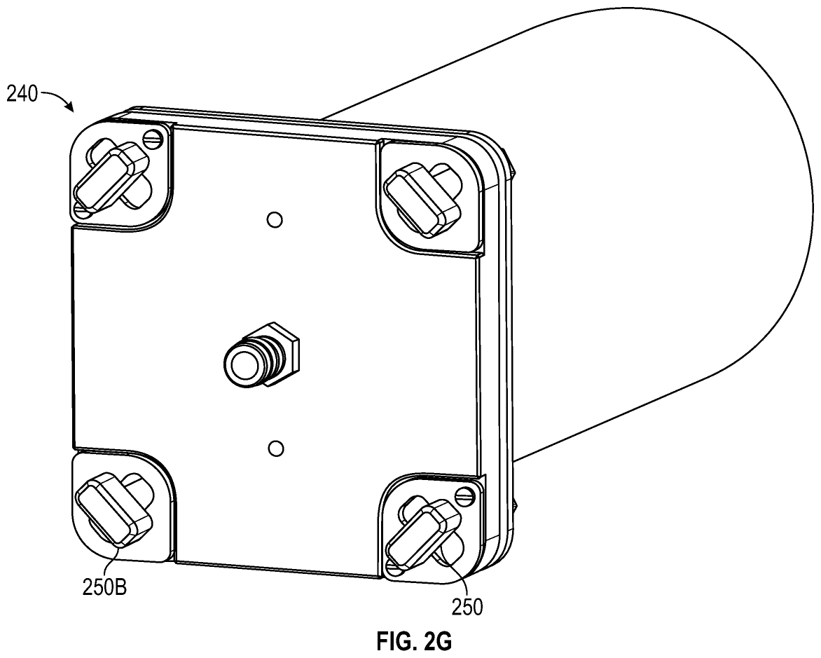

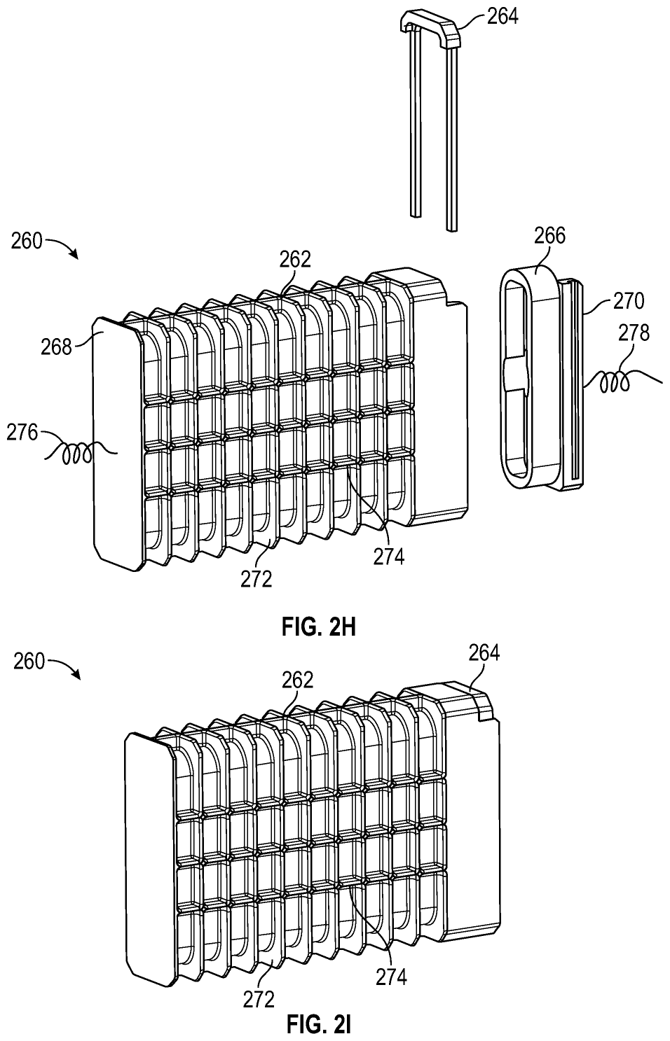

In FIGS. 2A-21, illustrations depicting various lid and/or door devices are shown, according to various embodiments. FIG. 2A shows a pressurized vessel 200 with a cover 202 and a body 204. In this example, the cover 202 includes one or more teeth 206 and one or more sealing areas 210. Further, the body 204 includes one or more shelve areas 208. In this example, the one or more teeth 206 interact with (e.g., engage, are placed under, etc.) the one or more shelve areas 208 to form an air tight seal between the body 204 and the cover 202 which can be seen in FIG. 2B.

FIG. 2C shows a pressurized vessel 214 with a cover 218 and a body 216. In this example, the cover 218 includes one or more attachment devices 220 and one or more cover sealing areas 226. Further, the body 216 includes one or more holes 222 and one or more body sealing areas 224. In this example, the one or more attachment devices 220 interact with (e.g., engage, are placed under, are placed in, etc.) the one or more holes 222 to form an air tight seal between the body 216 and the cover 218 which can be seen in FIG. 2D. In this example, the one or more attachment devices 220 go through the one or more holes 222 and are tightened into a locked position. In addition, a cover plate 230 and a body plate 232 may provide structural support for the sealing function.

FIG. 2E shows a pressurized vessel 240 with a cover 244 and a body 242. In this example, the cover 244 includes one or more attachment devices 252, one or more cover sealing areas 253, and a cover connection fitting 248. Further, the body 242 includes one or more body attachment devices 250, one or more body sealing areas 255, and a body connection fitting 246. In this example, the one or more attachment devices 252 interact with (e.g., engage, are placed under, are placed in, etc.) the one or more body attachment devices 250 to form an air tight (and/or water tight) seal between the body 242 and the cover 244 which can be seen in FIG. 2G. In this example, the one or more body attachment devices 250 go through the one or more attachment devices 252 and are tightened into a locked position. In addition, the cover connection fitting 248 engages with the body connection fitting 246 to form a sealed pathway. Further, the one or more cover sealing areas 253 and the one or more body sealing areas 255 form a sealed component. In one example, the one or more attachment devices 250 are in an open (e.g., unlocked) position 250A shown in FIG. 2F. In another example, the one or more attachment devices 250 are in a locked position 250B shown in FIG. 2G.

FIG. 2H shows a cartridge device 260 (e.g., a pressure canister cartridge device) with a body 262, a connecting device 264, and a cover 266. The cartridge device 260 may be pressurized device and/or a non-pressurized device. In one example, the cartridge device 260 is a pressurized device where the body 262 includes a vertical support structure 272 and a horizontal support structure 274 to increase the allowable operating pressure. In addition, the body 262 may include an engagement area 268 which includes a spring 276 for loading and/or unloading the cartridge device 260. In one example, the connecting device 264 engages both the body 262 and the cover 266 to form a sealed connection which is shown in FIG. 2I. In one example, the cover 266 may include an engagement area 270 and a spring 278 for loading and/or unloading the cartridge device 260.

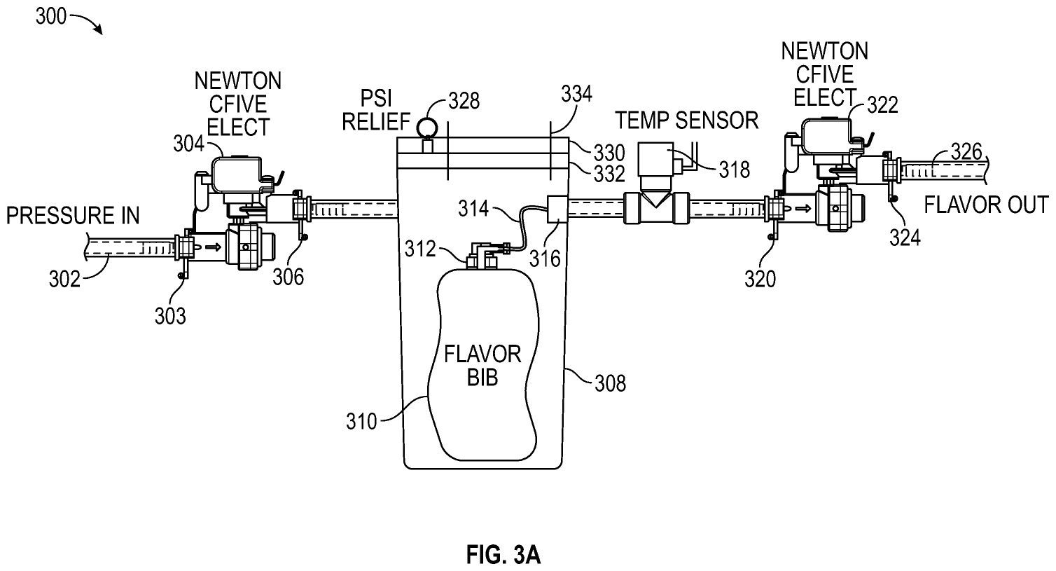

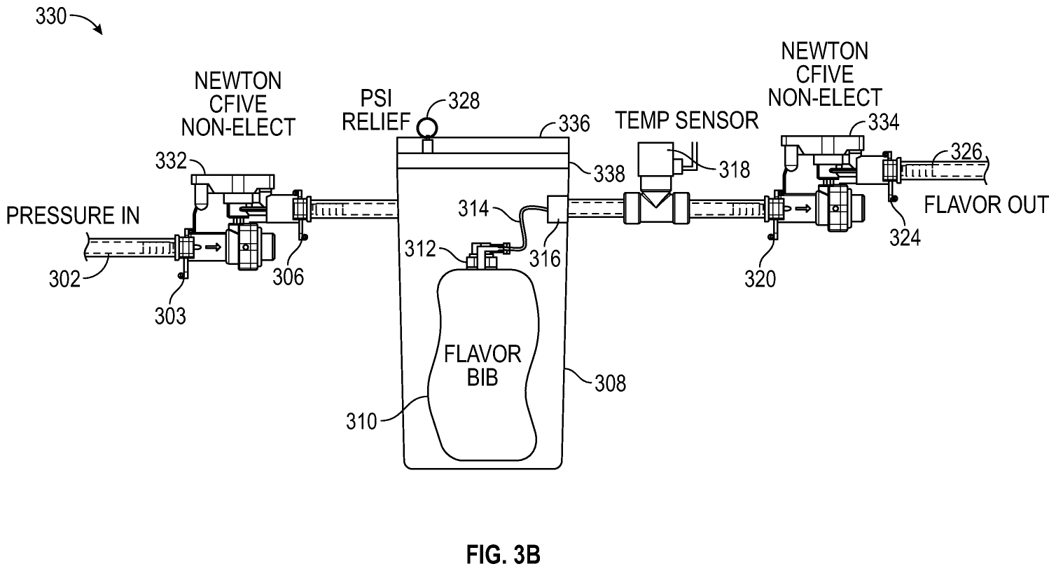

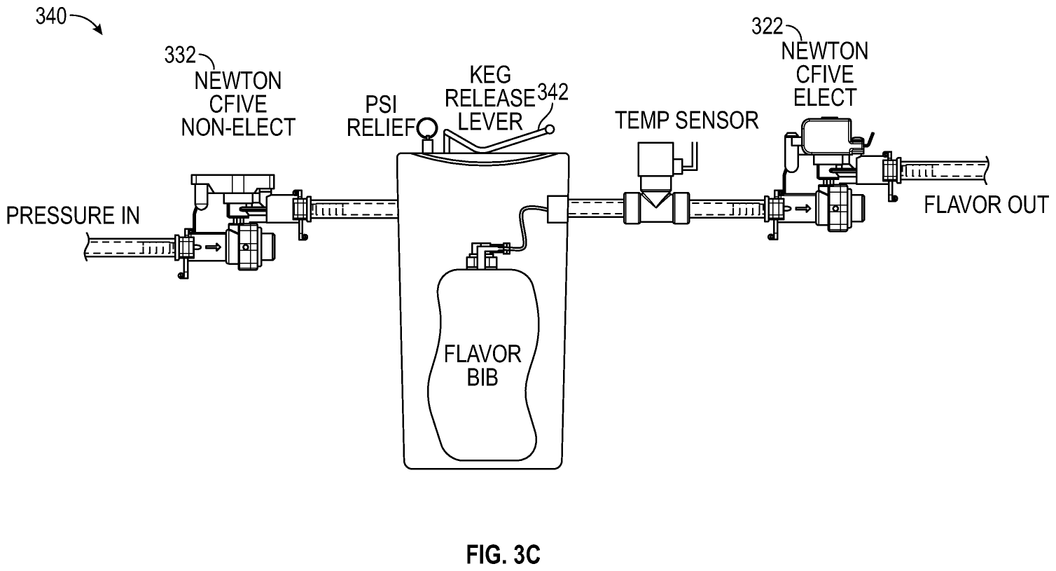

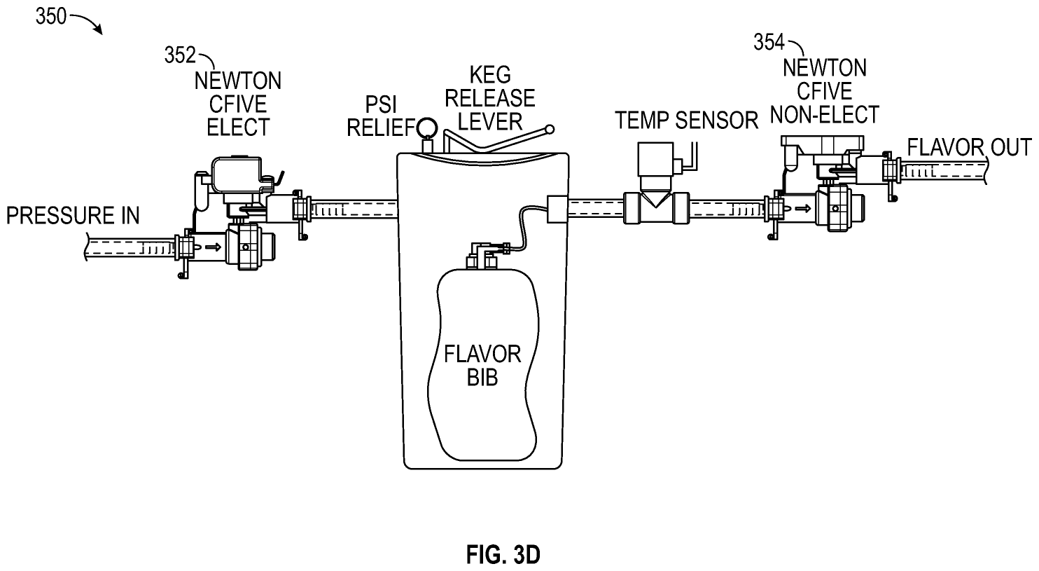

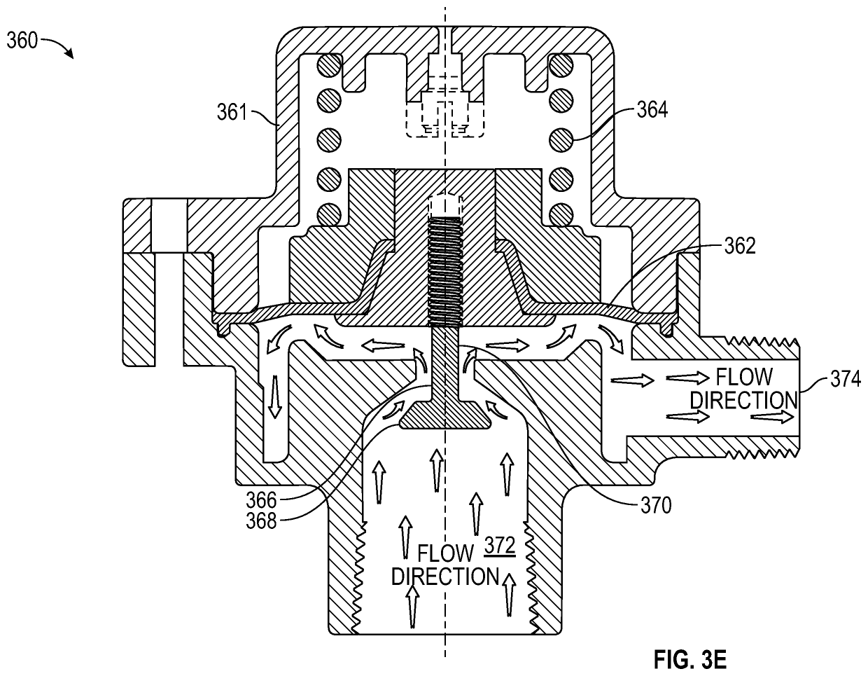

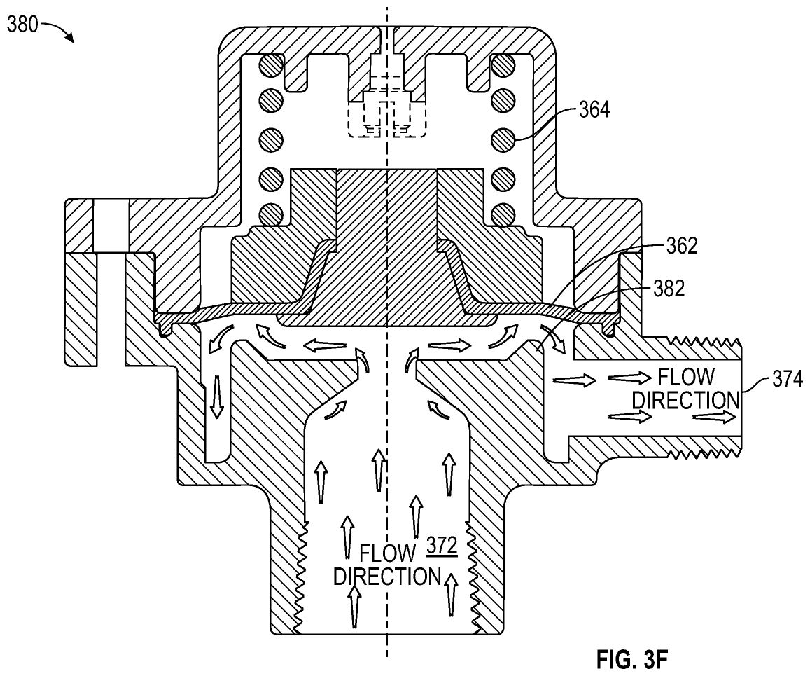

In FIGS. 3A-3D, illustrations of CF Valves being utilized before and/or after the pressurized container containing a bag are shown, according to various embodiments. FIG. 3A shows a pressurized dispensing system 300 including a pressure source 302 (e.g., pressure inlet area), a first disconnect device 303, a first CFiVe device 304 (e.g., a CF Valve and a solenoid), a second disconnect device 306, a pressurized vessel 308, a bag 310, a bag outlet 312, a tube 314, a pressurized vessel outlet 316, a temperature sensor 318, a third disconnect device 320, a second CFive device 322 (e.g., a CF Valve and a solenoid), a fourth disconnect device 324, and a flavor out area 326 (e.g., dispensing area). In one example, the pressurized vessel 308 includes a PSI relief device 328. In addition, the pressurized vessel 308 may include a cover 330, a body engagement area 332, and/or one or more securing devices 334 which are the same as shown in FIGS. 2C-2D. In addition, any of the lid/cover/cartridge configurations utilized in FIGS. 2A-21 can be utilized with and/or to replace pressurized vessel 308.

In an example, the temperature sensor 318 can provide temperature and/or humidity data to the system. In one example, if the flavor fluid viscosity is sensitive to temperature and/or humidity, the temperature and/or humidity data can be utilized to change the on-time of the first CFiVe device 304 (e.g., a CF Valve and a solenoid) and/or the second CFive device 322 (e.g., a CF Valve and a solenoid) which changes the flow rate of the flavor fluid to account for any changes in its viscosity so that the same portion is dispensed to achieve a certain flow rate quantity to the point of dispensing.

FIG. 3B shows a pressurized dispensing system 330 including the pressure source 302 (e.g., pressure inlet area), the first disconnect device 303, a first non-electric CFiVe device 332 (e.g., a CF Valve), the second disconnect device 306, the pressurized vessel 308, the bag 310, the bag outlet 312, the tube 314, the pressurized vessel outlet 316, the temperature sensor 318, the third disconnect device 320, a second non-electric CFive device 334 (e.g., a CF Valve), the fourth disconnect device 324, and the flavor out area 326 (e.g., dispensing area). In one example, the pressurized vessel 308 includes the PSI relief device 328. In addition, the pressurized vessel 308 may include a cover 336 and a body engagement area 338 which are the same as shown in FIGS. 2A-2B. In addition, any of the lid/cover/cartridge configurations utilized in FIGS. 2A-21 can be utilized with and/or to replace pressurized vessel 308. In addition, the pressurized vessel 308 may include the cover 330, the body engagement area 332, and/or one or more securing devices 334 which are the same as shown in FIGS. 2C-2D.

In one example, the second non-electric CFive device 334 does not have a solenoid for dispensing one or more elements (e.g., flavors, syrups, water, CO₂ water, nitrogen, anything else in this disclosure, etc.). In using this system, a mechanical outlet/shut off (e.g., a ball valve, tap, etc.) can be added or the dispensing can be handled downstream in the equipment utilizing solenoids or other forms of on-off features. Further, once the flow is shut downstream of the second non-electric CFive device 334, the first non-electric CFiVe device 332 (e.g., a CF Valve) will shut down automatically which will not allow any further pressure to flow into the canister. This will maintain the canister pressure at the targeted rate (e.g., 14 PSI, 21 PSI, 29 PSI, any other pressure in this disclosure, etc.) as the throttle pin in the first non-electric CFiVe device 332 (e.g., a CF Valve) will shut in the bridged position (e.g., throttle pin closing on inlet orifice). Therefore, no additional pressure (and/or fluid and/or gas) will pass through the first non-electric CFiVe device 332 (e.g., a CF Valve) into the canister. At the same time the second non-electric CFive device 334 will also shut in the bridge position as described above. In one example, at the time that the flow is opened downstream of the second non-electric CFive device 334, both the first non-electric CFiVe device 332 (e.g., a CF Valve) and the second non-electric CFive device 334 (e.g., a CF Valve) will open and operate normally allowing the perfect flow rate/quantity of one or more elements (e.g., flavors, syrups, water, CO₂ water, nitrogen, anything else in this disclosure, etc.) to be dispensed.

FIG. 3C shows a pressurized dispensing system 340 including the pressure source 302 (e.g., pressure inlet area), the first disconnect device 303, the first non-electric CFiVe device 332 (e.g., a CF Valve), the second disconnect device 306, the pressurized vessel 308, the bag 310, the bag outlet 312, the tube 314, the pressurized vessel outlet 316, the temperature sensor 318, the third disconnect device 320, the second CFive device 322 (e.g., a CF Valve and a solenoid), the fourth disconnect device 324, the flavor out area 326 (e.g., dispensing area), and/or a KEG release lever 342. In one example, the pressurized vessel 308 includes the PSI relief device 328. In addition, any of the lid/cover/cartridge configurations utilized in FIGS. 2A-21 can be utilized with and/or to replace pressurized vessel 308. In additional examples, the pressurized vessel 308 may include the cover 336 and the body engagement area 338 which are the same as shown in FIGS. 2A-2B. In addition, the pressurized vessel 308 may include the cover 330, the body engagement area 332, and/or one or more securing devices 334 which are the same as shown in FIGS. 2C-2D. In addition, any of the lid/cover/cartridge configurations utilized in FIGS. 2A-21 can be utilized with and/or to replace pressurized vessel 308.

FIG. 3C is different than FIG. 3B because a solenoid controls the outlet of the second CFive device 322 (e.g., a CF Valve and a solenoid). The configuration allows the solenoid to serve to open and close the flow of one or more elements (e.g., flavors, syrups, water, CO₂ water, nitrogen, anything else in this disclosure, etc.) to the dispense point, therefore, not requiring any additional mechanical and/or electrical actuation. Similar to FIG. 3B, when the second CFive device 322 (e.g., a CF Valve and a solenoid) is shut with the solenoid, the first non-electric CFiVe device 332 (e.g., a CF Valve) will go into a bridge position and not allow further pressure or fluid to flow into the canister. Once the second CFive device 322 (e.g., a CF Valve and a solenoid) is reopened, the first non-electric CFiVe device 332 (e.g., a CF Valve) is automatically reopened allowing the controlled pressure to move into the canister.

FIG. 3D shows a pressurized dispensing system 350 including the pressure source 302 (e.g., pressure inlet area), the first disconnect device 303, a first electric CFiVe device 352 (e.g., a CF Valve and solenoid), the second disconnect device 306, the pressurized vessel 308, the bag 310, the bag outlet 312, the tube 314, the pressurized vessel outlet 316, the temperature sensor 318, the third disconnect device 320, the second non-electric CFive device 354 (e.g., a CF Valve), the fourth disconnect device 324, the flavor out area 326 (e.g., dispensing area), and/or the KEG release lever 342. In one example, the pressurized vessel 308 includes the PSI relief device 328. In addition, any of the lid/cover/cartridge configurations utilized in FIGS. 2A-21 can be utilized with and/or to replace pressurized vessel 308. In additional examples, the pressurized vessel 308 may include the cover 336 and the body engagement area 338 which are the same as shown in FIGS. 2A-2B. In addition, the pressurized vessel 308 may include the cover 330, the body engagement area 332, and/or one or more securing devices 334 which are the same as shown in FIGS. 2C-2D. In addition, any of the lid/cover/cartridge configurations utilized in FIGS. 2A-21 can be utilized with and/or to replace pressurized vessel 308.

In FIG. 3E, an illustration of a CF Valve is shown, according to one embodiment. In this example, a CF Valve 360 includes a body 361, a diaphragm 362, a spring 364, a throttle pin 366, a throttle pin head 368, a throttle pin stem 370, an inlet area 372, an outlet area 374, and/or one or more barrier walls 382 (see FIG. 3F).

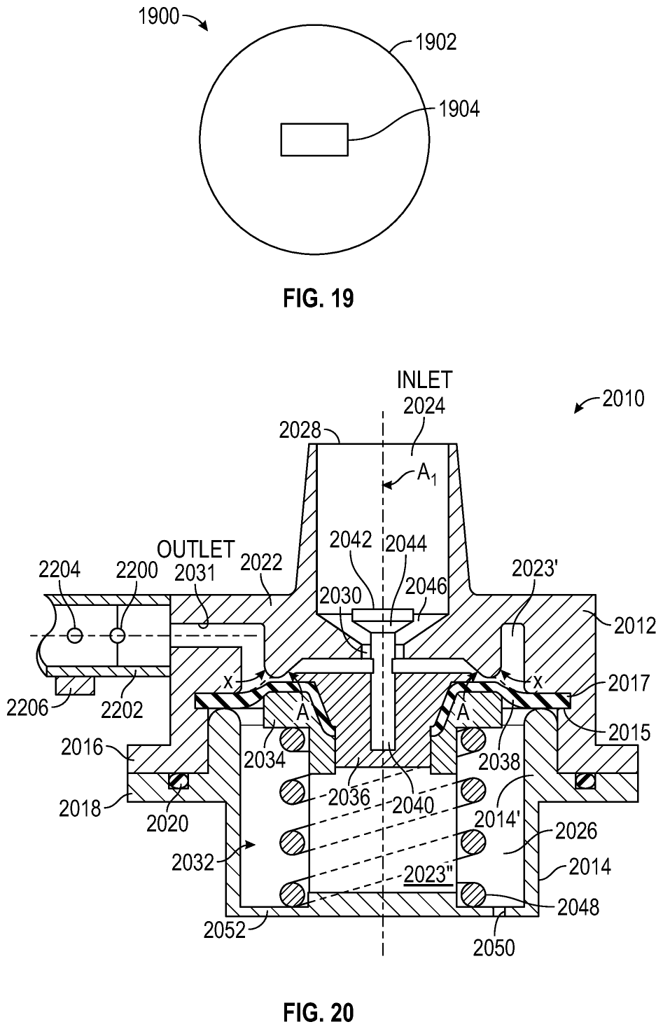

In FIG. 3F, an illustration of a CF Valve without a throttle pin is shown, according to one embodiment. In this example, a CF Valve 380 includes the body 361, the diaphragm 362, the spring 364, the inlet area 372, the outlet area 374, and/or one or more barrier walls 382. In one example, the CF Valve 380 which does not include a throttle pin will change the characteristics of the CF Valve. For example, CF Valve 380 will act as a pressure relief valve and CF Valve 380 will open when the threshold pressure of the spring and diaphragm is reached (e.g., 7 PSI, 14 PSI, 21 PSI, etc.). The benefit of this system is that there is no electronics on the outlet so that it can be easily washed and has no need for wires connecting to the machine. In one example, if the CF Valve 380 is mounted to the lid of the canister (see FIG. 19), the entire lid can be removed and placed in the sink, dishwasher, or cleaned by a clean-in-place device. In various examples shown in FIGS. 3A-3D, the CF Valves with the throttle pins may be exchanged for the CF Valves without a throttle pin (e.g., CF Valve 380). However, the CF Valves without a throttle pin will be pressure relief valves.

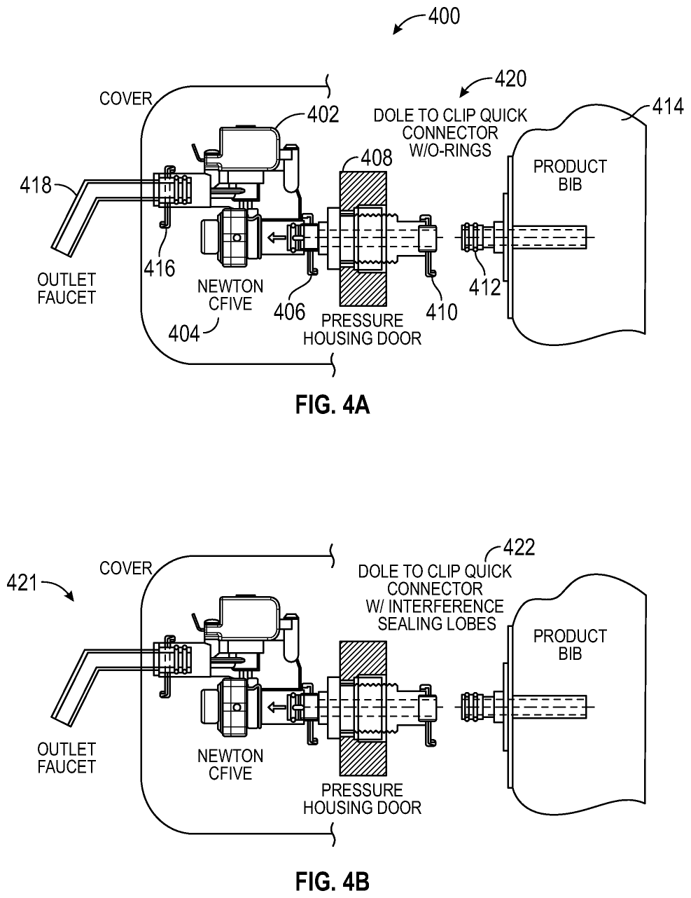

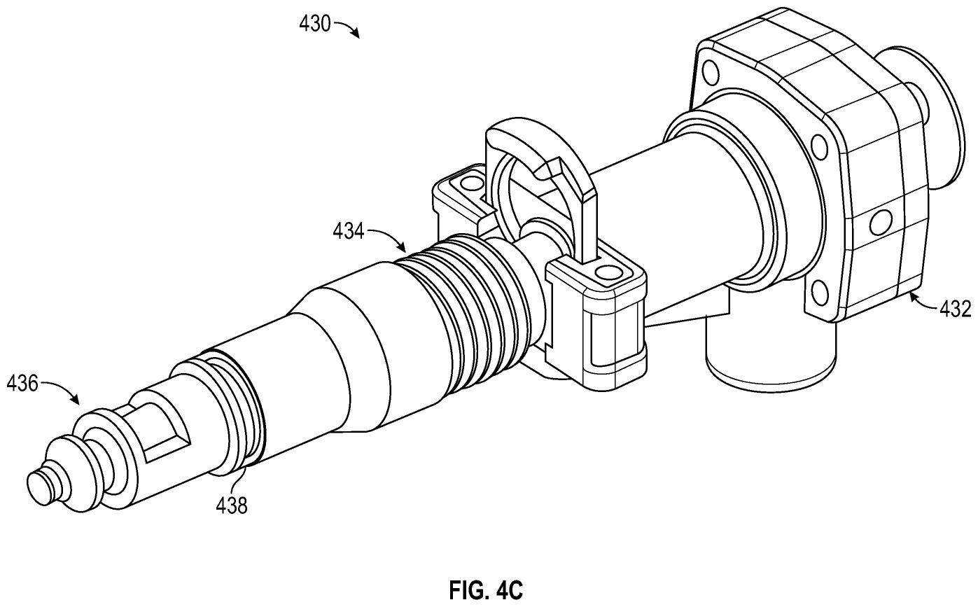

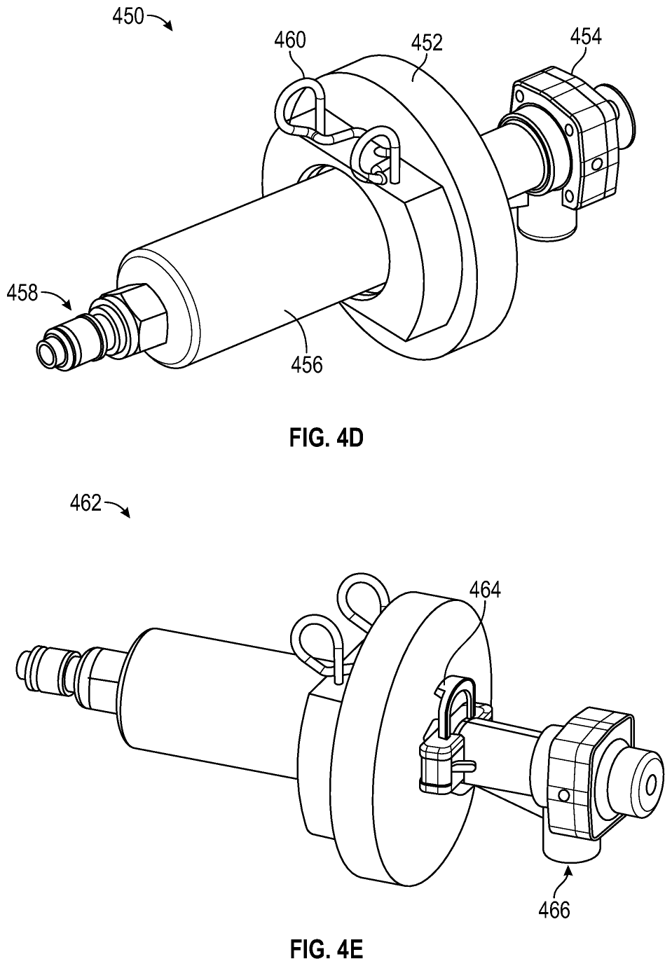

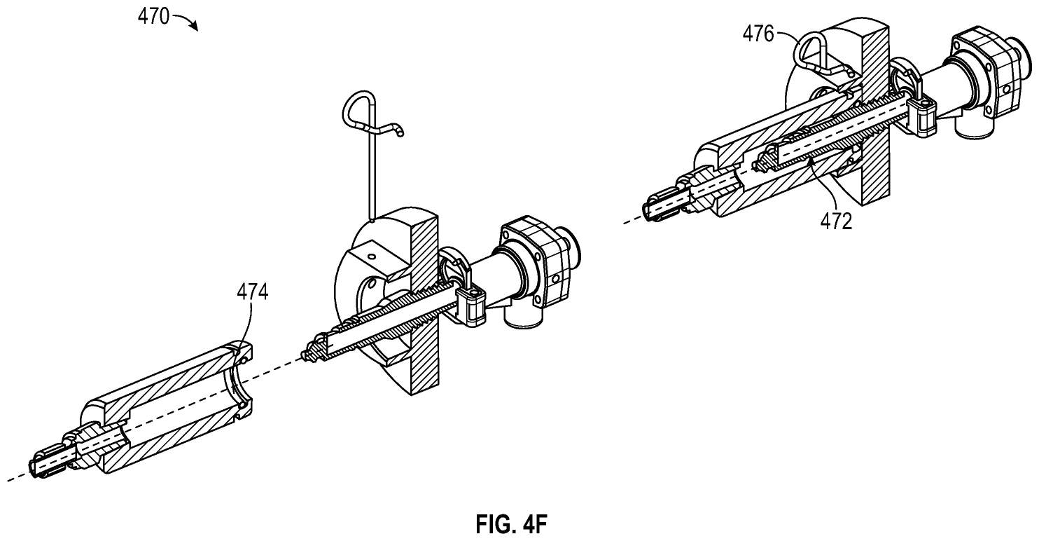

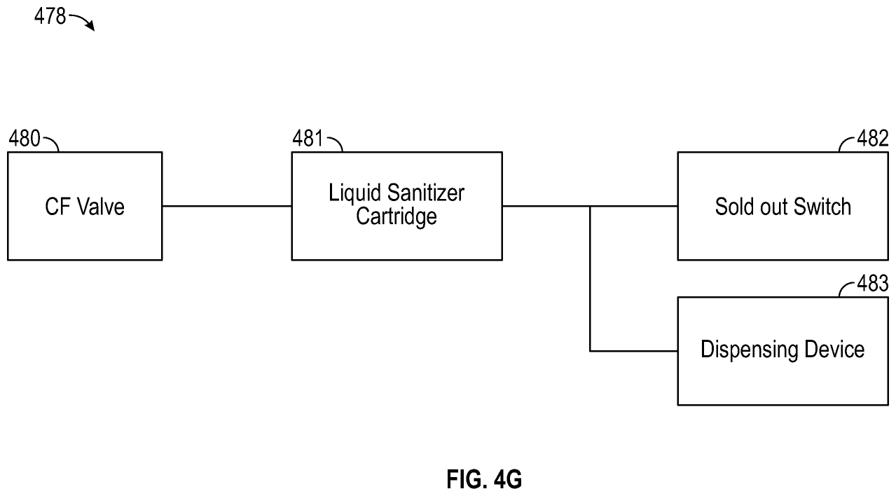

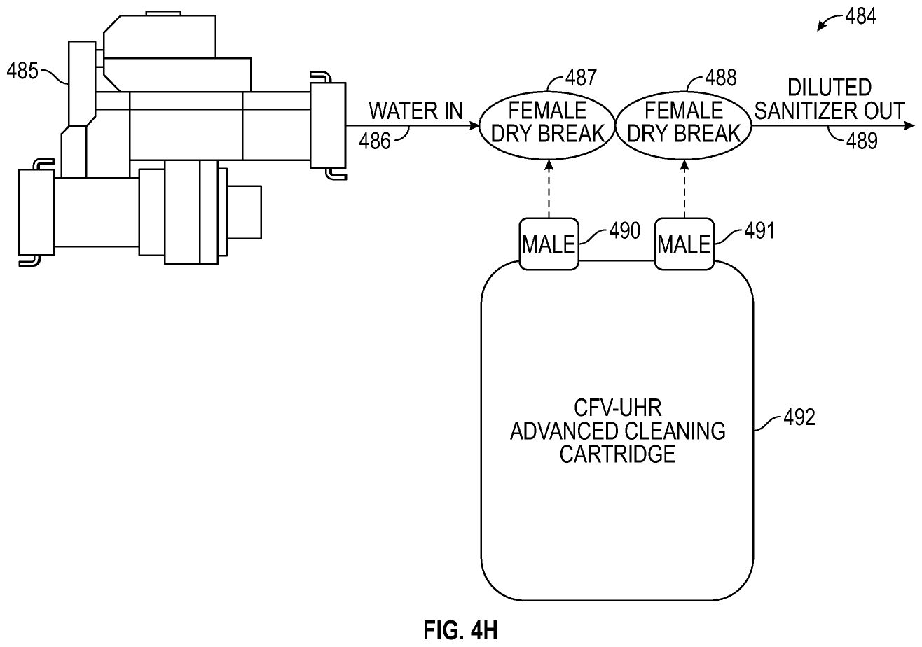

In FIGS. 4A-4B, illustrations of CF Valves being utilized after the pressurized container containing a bag are shown, according to various embodiments. FIG. 4A shows a dispensing system 400 including a CF Valve 402, a solenoid 404, a first dry break 406, a pressurized housing door 408, a second dry break 410, a bulkhead connection 412, an ingredient bag 414, a third dry break 416, and/or a dispensing area 418. In this example, a dole to cup quick connector with an O-ring 420 is utilized. In this example, the CF Valve by the faucet (dispensing area 418) connects directly to the ingredient bag 414 that is inside the pressurized canister, pressurized vessel, and/or cartridge. In addition, this can be done using a quick connect fitting that mates with an O-ring fitting into the bag.

FIG. 4B shows a dispensing system 421 including the CF Valve 402, the solenoid 404, the first dry break 406, the pressurized housing door 408, the second dry break 410, the bulkhead connection 412, the ingredient bag 414, the third dry break 416, and/or the dispensing area 418. In this example, a dole to cup quick connector with interference sealing lobes 422 is utilized. In this example, the CF Valve by the faucet (dispensing area 418) connects directly to the ingredient bag 414 that is inside the pressurized canister, pressurized vessel, and/or cartridge. In addition, this can be done using a quick connect fitting that mates with an interference fitting into the bag. In various examples shown in FIGS. 4A-4B, the CF Valves with the throttle pins may be exchanged for the CF Valves without a throttle pin (e.g., CF Valve 380). However, the CF Valves without a throttle pin will be pressure relief valves.

In FIGS. 4C-4F, illustrations of a fitting being utilized to connect the bag to the faucet are shown, according to various embodiments. In FIG. 4C, a fitting 430 includes an external end 432, a thread 434, an inside end 436, and/or an O-ring 438. In one example, the fitting 430 is a connection device between the ingredients bag 414 and the dispensing area 418. In this example, the fitting 430 connects with the ingredients bag 414 via the inside end 436 entering the ingredients bag 414. In addition, the fitting 430 connects with the dispensing area 418 via the external end 432.

In FIG. 4D, a fitting 450 includes a lid 452, a faucet 454, a cleaning fixture/sleeve 456, a dry break 458, and/or a retaining clip 460. In this example, the CFive on the faucet side and/or dispensing side may connect to the bag inside the pressurized vessel with a connection fitting 450. In this example, the fitting 450 connects the bag to dispensing area through the lid. In another example, the canister and/or lid can have an additional feature that holds the cap in the bag in place to make insertion of the connection directly into the bag consistent (e.g., no side loading).

In FIG. 4E, a fitting 462 includes a clip 464 and a faucet outlet 466. In this example, the cleaning fixture can be connected to the inside of the lid for a clean-in-place functionality. In addition, the fitting 462 will allow for cleaning and/or sanitizing fluid to clean the outside and inside of the fitting and to pass through the fitting and out the CF Valve by the faucet to clean all wetted surfaces. In FIG. 4F, a fitting 470 includes various internal elements 472, an O-ring 474, and/or a retaining clip 476. In one example, cleaning/sanitizing fluid cleans outside of probe fitting pas Cap/Bag O-ring seal (e.g., wetted surfaces). In another example, the O-ring in the sleeve seals to bottom of probe. In another example, the retaining clip keeps sleeve/fixture in place when pressurized.

FIG. 4G shows a cleaning-in-place device 478. Cleaning-in-place device 478 includes a CF Valve 480, a liquid sanitizer cartridge 481, a sold-out switch 482, and/or a dispensing device 483. In one example, the sold-out switch 482 indicates and/or warning that the system is in a sold-out condition, maintenance condition, and/or any other condition where delivery of a dispensed product is unavailable. The CF Valve 480 provides the liquid, gas, and/or pressure to move one or more cleaning and/or sanitizer elements out of the liquid sanitizer cartridge 481 to the dispensing device 483 for cleaning and/or sanitizing functions.

In FIG. 4H, an illustration of a bag-in-bottle sanitation system is shown, according to one embodiment. A sanitization system 484 may include a CF Valve 485 (e.g., CFives—CF Valve with a solenoid) which provides a water in flow 486 to a first female dry break 487 which is coupled to a first male counterpart 490 on the cartridge 492 (e.g., cleaning, sanitizer, etc.) which is coupled to a second male counterpart 491 which is coupled to a second female dry break 488 which produces a diluted solution (e.g., cleaning, sanitizer, etc.). This cartridge system can be utilized with any other system disclosed in this document.

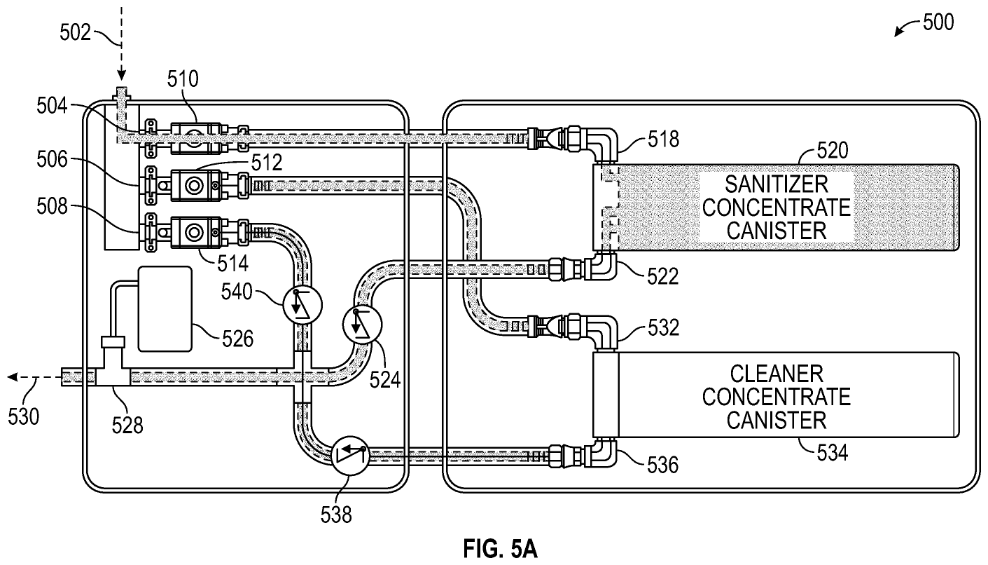

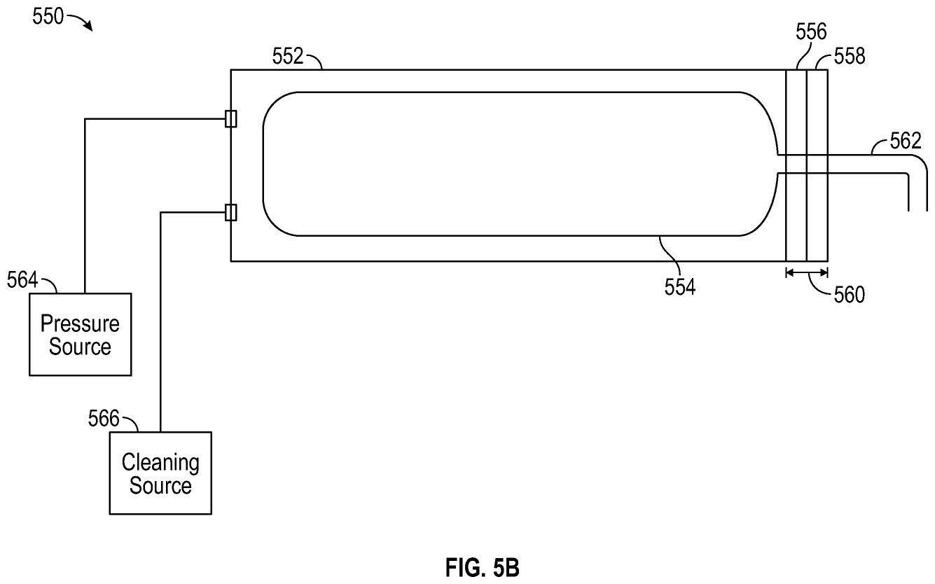

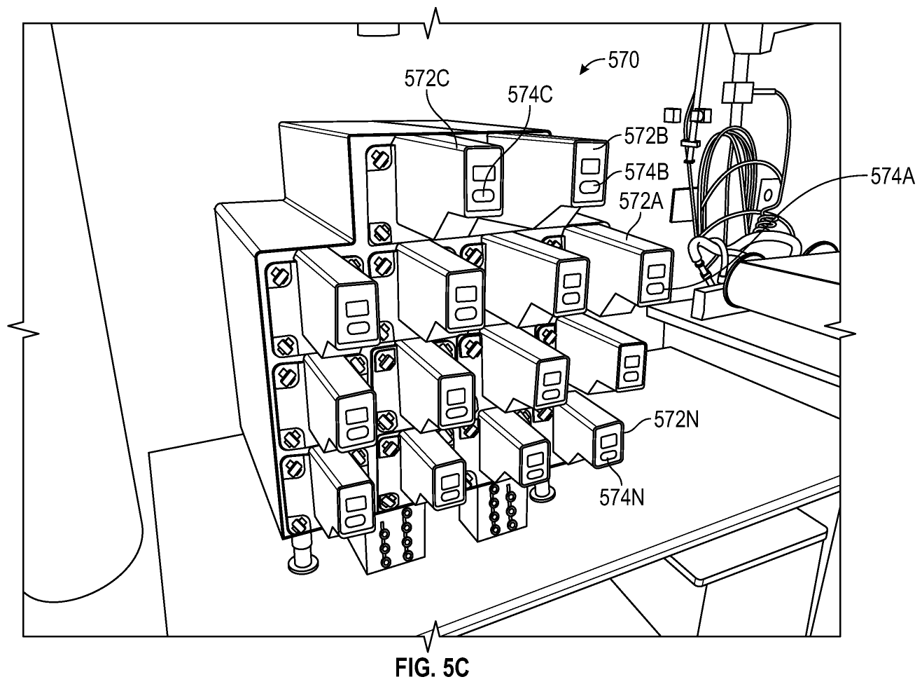

In FIGS. 5A-5C, illustrations of a cleaning system are shown, according to various embodiments. In FIG. 5A, an illustration of a sanitation system is shown, according to one embodiment. A sanitation system 500 may include a water supply inlet 502, a sanitizer CF Valve circuit 504, a cleaner CF Valve 506 circuit, a water flush circuit 508, a sanitizer CF Valve 510 (e.g., CFive), a cleaner CF Valve 512 (e.g., CFive), a water flush CF Valve 514 (e.g., CFive), a first water inlet dry break fitting 518, a sanitizer concentrate canister 520, a first diluted sanitizer outlet dry break fitting 522, a first check valve 524, a total dissolved solids controller 526 with one or more sensors, a total dissolved solids TDS meter and sensors 528, a diluted solution outlet 530, a second water inlet dry break fitting 532, a cleaner concentrate canister 534, a diluted cleaner outlet dry break fitting 536, a second check valve 538, and/or an Nth check valve 540. In various examples, the system can have only one canister or up to Nth canisters (e.g., 1-1,000).

The water source (i.e.: city water) enters the system through and passes by a pressure regulator through a T the water is directed to the two CFiVes that control the UHR system, the CFiVe controls the pressure of the water to the targeted Pressure into the Canisters, the water enters the canister through the Manifold water inlet and pressurizes the bag of active ingredient which pushes active ingredient through the tube orifice into the mixing manifold where it mixes with water and flows back into the machine through the flow meter/total dissolved solids sensor and into the manifold via the incoming sanitation solenoid, one the cleaning or sanitation mixed solution is in the solenoid manifolds it then passes through each of the various solenoids downstream to sanitize/clean that particular circuit in the system.

In FIG. 5B, a cleaning system 550 includes a pressure vessel 552, a bag 554, a body attachment area 556, a lid 558, a dispensing area 562, a pressure source 564, and/or a cleaning source 566. In one example, an attachment element 560 may include the body attachment area 556 and the lid 558. In another example, the cleaning source 566 may be utilized with the bag 554 being removed and/or the bag containing cleaning elements.

In FIG. 5C, a dispensing system 570 includes a first dispensing device 572A with a first dispensing button 574A, a second dispensing device 572B with a second dispensing button 574B, and/or an Nth dispensing button 572N with an Nth dispensing button 574N. In various examples, one or more of the dispensing devices (e.g., 572A, 572B, . . . , 572N) utilize one or more dispensing device configuration described in this disclosure (e.g., FIGS. 1A-1D, 3A-3F, 4A-4F, 6A-6E, 7A-7D, 8, 9A-9B, and/or 14A-15C). In one example, the system includes several pressure canisters each dispensing a different fluid and/or gas (e.g., flavor element, water, CO₂, nitrogen, etc.). In this example, each of these pressure canisters is controlled with an electronic control board covering and/or coupled to the CF Valve on the faucet side with a screen that may display the fluid name and/or gas name. In this example, by pressing any of the dispensing buttons (e.g., the first dispensing button 574A, the second dispensing button 574B, . . . , and/or the Nth dispensing button 574N), the dispensing system will provide one dose of the fluid and/or gas where the dose is a predetermined amount in volume and/or weight.

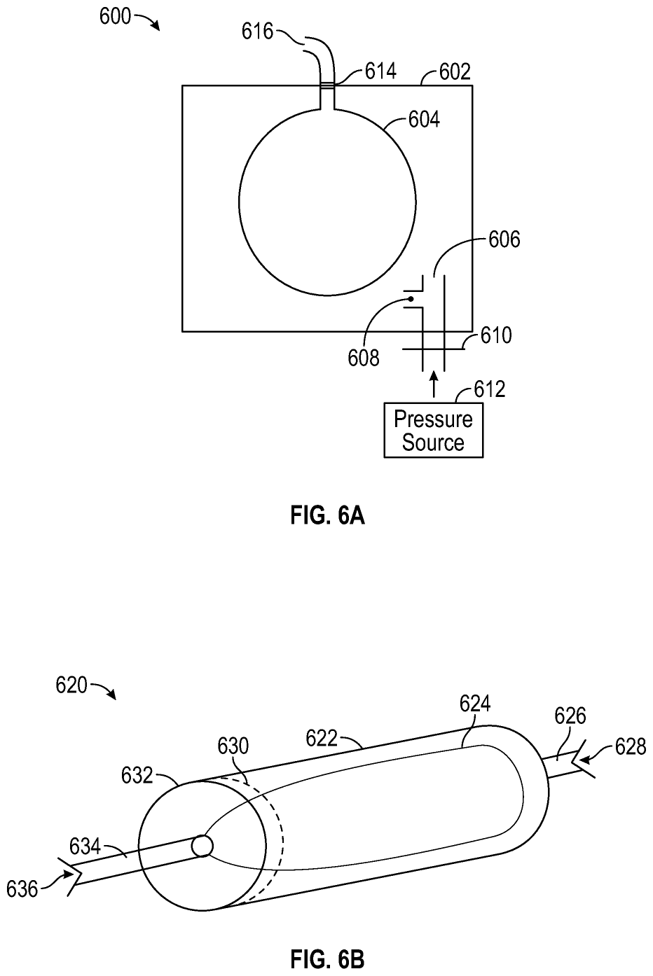

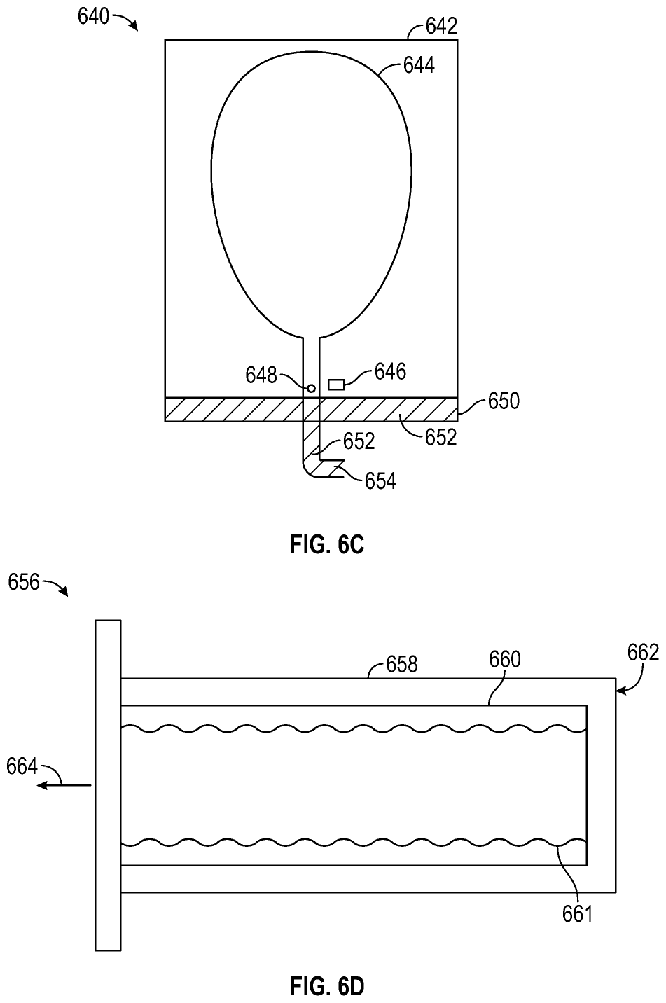

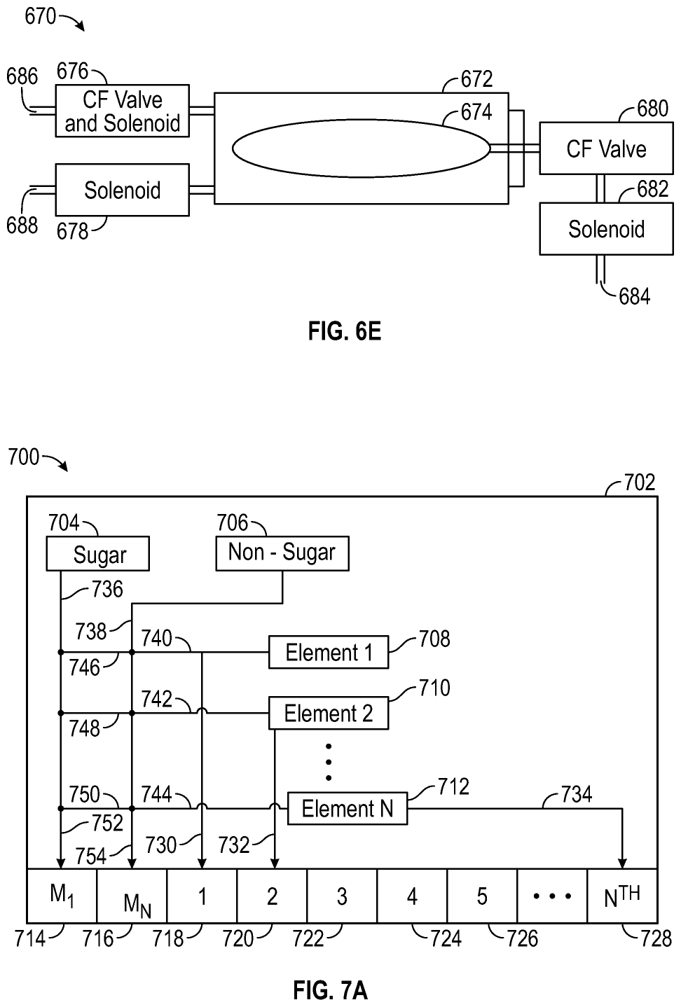

In FIGS. 6A-6E, illustrations of the pressurized container containing a bag are shown, according to various embodiments. FIG. 6A shows a dispensing system 600 including a pressure vessel 602, an element bag 604 (e.g., ingredients, flavors, gases, liquids, etc.), a check valve 606, an orifice 608, a first disconnect device 610, a pressure source 612, a second disconnect device 614, and/or a dispensing area 616. In one example, the canister can be disconnected from the pressure source 612 via the first disconnect device 610 which automatically depressurizes mechanically when the canister is disconnected. In this example, the canister may be connected with a latching/spring mechanism for the connection and/or disconnection functionality.

In FIG. 6B, a canister 620 includes a canister body 622, a bag 624, an input area 626, a first disconnect device 628, a threaded area 630, a lid 632 (e.g., cap, etc.), an outlet area 634, and/or a second disconnect device 636. In one example, the threaded area 630 of the canister body 622 may be coupled to the lid 632 to form an air tight connection and/or bond. In one example, the lid closure for the canister may be air right and when pressurized cannot be removed for safety purposes. In one example, a threaded lid can be placed onto the canister before it is pressurized and when it is pressurized the lid cannot be removed as the pressure on the inside of the lid acts to hold the lid in place until the canister is depressurized and the lid can be removed. In another example, there can be a latching mechanism that acts to hold the lid in place and when the latch is unhooked it automatically releases the pressure from the canister. Further, the lid may have teeth that mate to the canister and when pressurized the pressure pushes the lid against the teeth locking mechanism and acts to hold the lid where simple hand-force cannot remove the lid.

In FIG. 6C, a dispensing system 640 includes a pressure vessel 642, a bag 644, a movement device 646, a ball 648, a connection area 650, and/or a dispensing area 654. In one example, the movement device 646 (e.g., an electro-magnet) is turned on and off to move the ball 648. The dispensing system 640 may be turned on and off by the position of the ball 648 which is controlled either by the force of the movement device 646 (e.g., the dispensing system is on) or by the force of the elements in bag 648 (e.g., the dispensing system is off). In another example, a clean-in-place system may clean the wet areas 652. In this example, all of the electrical components stay inside the canister or outside the canister but not on the lid in order that there is no requirement to clean the solenoid or electrical components and the wetted surfaces can be cleaned via a clean-in-place system, and/or in a dishwasher.

In FIG. 6D, a dispensing system 656 includes a vessel with an outer body 658 and an inner body 660. In this example, the outer body 658 may be made of a strong material (e.g., metal). In this example, the inner body 660 may be made of a weaker material (e.g., plastic). In this example, an accumulation area 662 may be an area where one or more gases accumulate (e.g., compressed air, etc.). In addition, the dispensing system 656 may include a lid 664 on the vessel. Further, a container 661 may be inside of the inner body 660. In this example, the pressure vessel has an outer sealed skin that is pressurized with the same fluid acting to hold the inner plastic canister in place which strengthening its ability to hold the pressure of the fluid. In this example, the fluid can be used as an accumulator and used to pressurize the canister when dispensing.

In FIG. 6E, a dispensing system 670 includes a pressure vessel 672, a flexible bag 674, a first CF Valve 676 with a solenoid (e.g., a CFiVe valve), a second solenoid 678, a second CF Valve 680, a third solenoid 682, an outlet area 684 (e.g., dispensing area), a pressure input area 686, and/or a pressure outlet area 688. In this example, the dispensing system 670 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 27 PSI) and the second CF Valve 680 on the outlet of the canister operates at an operating pressure of Y (e.g., 14 PSI). In this example, the operating pressure of Y is less than the operating pressure of X. In addition, the second solenoid 678 acts to depressurize the pressure vessel 672 when the dispensing operation is completed. In one example, the first CF Valve 676 with a solenoid is opened and the canister is filled to the operating pressure X (e.g., 27 PSI) and as soon as the pressure in the pressure vessel 672 exceeds the operating pressure Y (e.g., 14 PSI) the second CF Valve 680 will open and dispense one or more elements (e.g., fluids, gas, etc.) from the flexible bag 674. In this example, when the appropriate amount of the one or more elements is dispensed, the second solenoid 678 will open to partially relieve the pressure from the pressure vessel 672 to under the threshold of the second CF Valve 680 operating pressure of Y. In various examples, the second CF Valve 680 may have a throttle pin and/or no throttle pin depending on the flow rate to be achieved by the one or more elements. In another example, the second solenoid 678 may be controlled with a set time to depressurize and/or with a pressure sensor to depressurize to a set pressure. There are many benefits to this dispensing system 670. For example, there are no electronics or electrical connections on the lid/cover of the pressure vessel 672 (which must be removed to replace the flexible bag 674 and to be cleaned). In another example, the first CF Valve 676 with a solenoid will open for 0.83 seconds to dispense 0.42 ounces of a fluid at 27 PSI, once the pressure vessel 672 fluid (e.g., fluid in bag) exceeds 15 PSI the second CF Valve 680 will open and dispense the one or more elements. Once the first CF Valve 676 with a solenoid closes, the second solenoid 678 will open for 0.7 seconds to relieve the pressure of fluid (e.g., fluid outside of the flexible bag 674) in the pressure vessel 672 to 12 PSI and the second CF Valve 680 will close which stops the dispensing of the one or more elements (e.g., liquid, gas, etc.). In another example, the second solenoid 678 can be controlled with a pressure sensor so that the second solenoid 678 opens and then closes when the pressure in the pressure vessel 672 reaches a targeted closing pressure (e.g., 12 PSI in the above-referenced example).

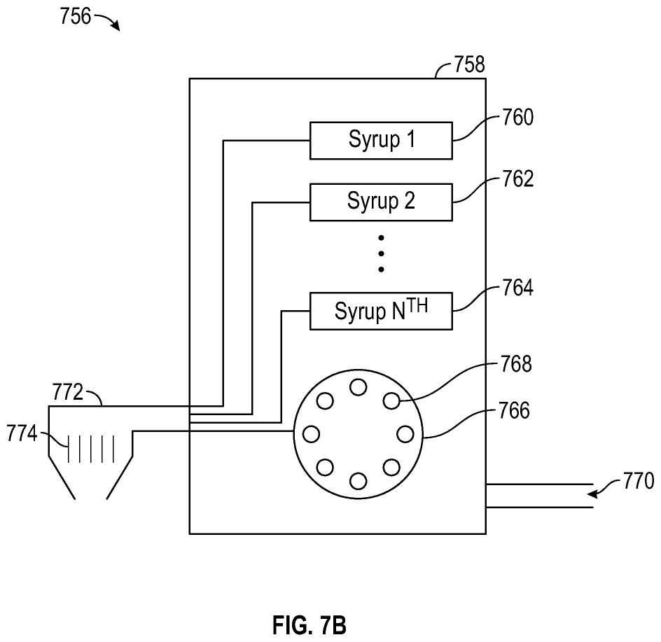

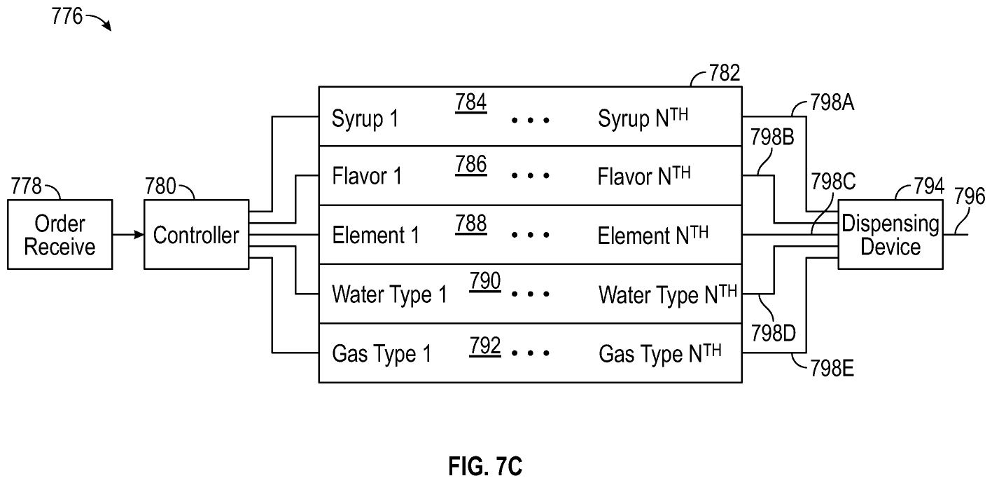

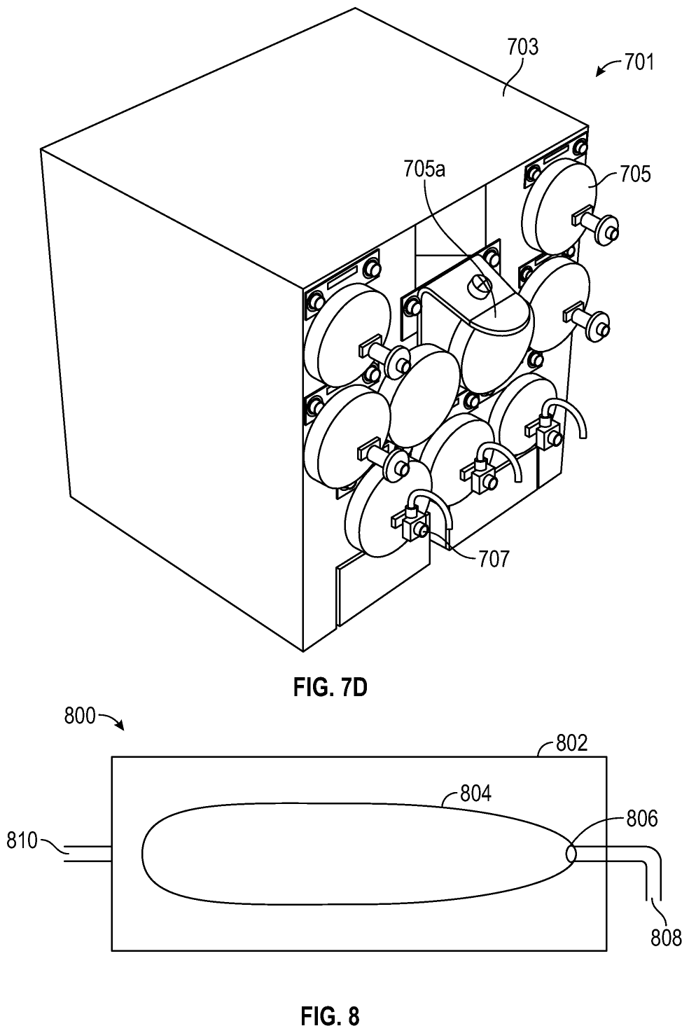

In FIGS. 7A-7D, illustrations of a customizable drink dispensing system are shown, according to various embodiments. FIG. 7A shows a dispensing system 700 including a housing 702, a sugar source 704 (e.g., a first ingredient source), a non-sugar source 706 (e.g., a second ingredient source), a first element source 708 (e.g., a third ingredient source), a second element source 710 (e.g., a fourth ingredient source), and/or an Nth element source 712 (e.g., an Nth ingredient source). In one example, the dispensing system 700 has a plurality of outlet areas (e.g., reference numbers 714, 716, 718, 720, 722, 724, 726, and/or 728). In one example, the plurality of outlets areas has two types of outlets: a) a multiple outlet area (e.g., a first multiple outlet area 714 and an Nth multiple outlet area 716) and b) a single outlet area (e.g., a first single outlet area 718, a second single outlet area 720, a third single outlet area 722, a fourth single outlet area 724, a fifth single outlet area 726, and/or an Nth single outlet area 728). In one example, the multiple outlet areas (e.g., 714 and 716) are outlet areas where two or more ingredient sources are dispensed to the multiple outlet area. In another example, the single outlet areas are outlet areas where only one ingredient is dispensed at a time. In various examples, utilizing various links (e.g., reference numbers 730, 732, 734, 736, 738, 740, 742, 744, 746, 748, 750, 752, and/or 754) a single ingredient may be dispensed to the single outlet areas (e.g., reference numbers 718, 720, 722, 724, 726, and/or 728) and/or two or more ingredients may be dispensed to the multiple outlet areas (e.g., reference numbers 714 and 716).

In one example, a system may include multiple fluids that can be sauces, syrups, flavors, concentrated beverages, concentrated ingredients, non-concentrated beverages, ingredients and/or other fluids and/or gases. In this example, the system may dispense one or more liquids and/or gas from a single dispensing point. For example, certain fluids can be dispensed together from a multi-flavor dispense head and mixed as they are dispensed into a cup, pitcher, and/or downstream into a mixing chamber. In addition, a single fluid can be dispensed on their own from a single dispense point or through a multiple-dispense point.

In another example, the system may use a CF Valve to pressurize the dispensing which has the benefit of being faster than traditional pump bottles or systems that utilize pumps and plumbing. In addition, the CF Valve system is safer for employees because there are fewer repetitive motion injuries (e.g., from reaching up and pumping down especially with viscous liquids that require significant force on the pump to operate). In addition, there is substantially less waste because the product is delivered in flexible packaging compared to standard bottles/jugs (the volume of waste and trips to the dumpster can be reduced by up to 60%). Further, the CF Valve dispensing system is substantially more accurate than manual pumps which can be over +/−20 percent off in dispensing the amount due to differences in how an employee pumps the bottle. In addition, the system can be +/−5 percent accurate dispensing the product. In addition, the system can be cleaned easier than existing pump-based systems. Further, some fluids can be concentrated which reduces space requirements for operations and storage. This also reduces the amount of changeover required because the material lasts longer.

In FIG. 7B, a dispensing system 756 includes one or more pressure vessels that are utilized to control the flow of one or more elements. The dispensing system 756 includes a housing 758 (with one or more pressure vessels), a first syrup source 760, a second syrup source 762, an Nth syrup source 764, a multiple flavor source 766 (with a plurality of flavors 768), and/or a dispensing area 722 with dispensed products 774. In one example, more than one bag may be in the pressure vessel. For example, a first ingredient and a second ingredient may be delivered from a first pressure vessel and a high ratio (30:1; 60:1; 100:1; etc.) element may be mixed from a second pressure vessel with either sugared or sugar-free syrup from a third pressure vessel all mixed together at a dispensing point and/or a mixing chamber.

FIG. 7C shows a dispensing system 776 including an order receiving device 778, a controller 780, a plurality of pressure vessel stacks 782, a first pressure vessel stack 784, a second pressure vessel stack 786, a third pressure vessel stack 788, a fourth pressure vessel stack 790, an Nth pressure vessel stack 792, and/or a dispensing device 794 with a dispensing area 796. In this example, the order receiving device 778 may be a mobile computer and a stationary computing device. In one example, an order is entering into the order receiving device 778 which is transmitted to the controller 780. In this example, the controller determines one or more recipes for the order and transmits one or more control signals to one or more of the plurality of pressure vessel stacks 782 which generates the order and delivers the order via one or more pathways (e.g., reference numbers 798A, 798B, 798C, 798D, and/or 798E) to the dispensing device 794 for dispensing into the dispensing area 796. In various examples, the one or more of the pressure vessel stacks in the plurality of pressure vessel stacks 782 may have any number of pressure vessels (e.g., 1, 2, 3, 4, 5, 6, 7, 8, 9, 10, 11, . . . , 100). In addition, each pressure vessel may contain one element and/or ingredient. Further, each pressure vessel may contain more than one element and/or ingredient. For example, the first pressure vessel stack 784 may contain a first stack with only a first syrup. In another example, the first pressure vessel stack 784 may contain 10 stacks with each stack containing a single different syrup in each stack. In another example, the first pressure vessel stack 784 may contain 10 stacks with 5 of the stacks containing a single different syrup in each stack and 5 of the stacks containing at least two different syrups in each stack. In another example, the second pressure stack 786 may contain 20 stacks with 4 of the stacks containing a single different flavor in each stack; 6 stacks containing two different flavors in each stack; 3 stacks containing 5 different flavors in each stack, 2 stacks containing 3 different flavors in each stack; and 5 stacks containing 12 different flavors in each stack.

FIG. 7D shows a dispensing system 701 with a housing 703, one or more pressurized vessels (705 and 705A), and/or one or more fittings 707. In FIG. 8, a dispensing system 800 with a pressure vessel 802, a bag 804, a fitting 806, and outlet area 808, and/or a pressure input area 810 is shown. In one example, the bag 804 is elongated and not completely filled with ingredients. In another example, the bag 804 has an outlet in the center of one end and a longer thinner shape to fit in the cylindrical canister (e.g., pressure vessel 802). This allows for the optimization of the amount of fluid that can be put into the bag 804 and minimizes the labor required to exchange the bag 804 when emptied for a new bag. In one example, utilizing a rectangular bag with a cap/outlet on one corner can generate 30-40 percent wasted space inside of the pressure vessel 802. By utilizing a longer thinner shape and having the outlet near the center, the wasted space is reduced to 10-15 percent.

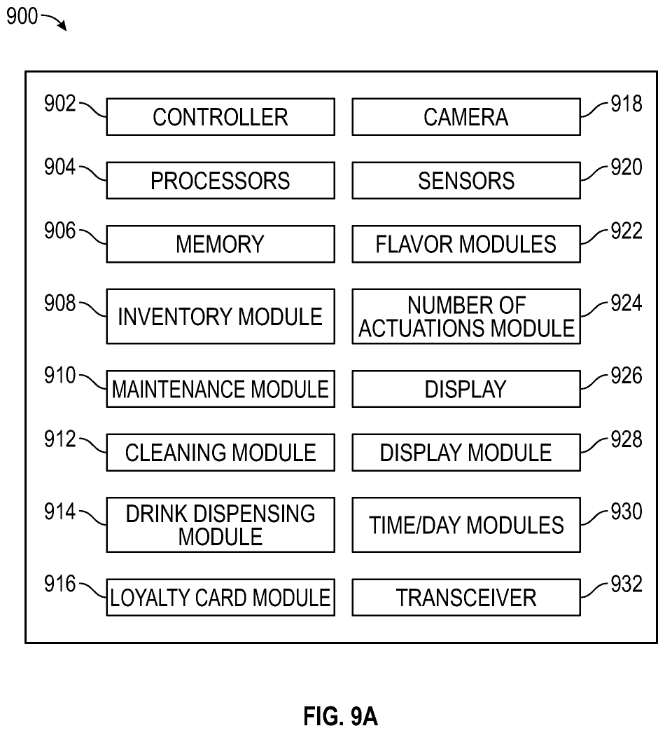

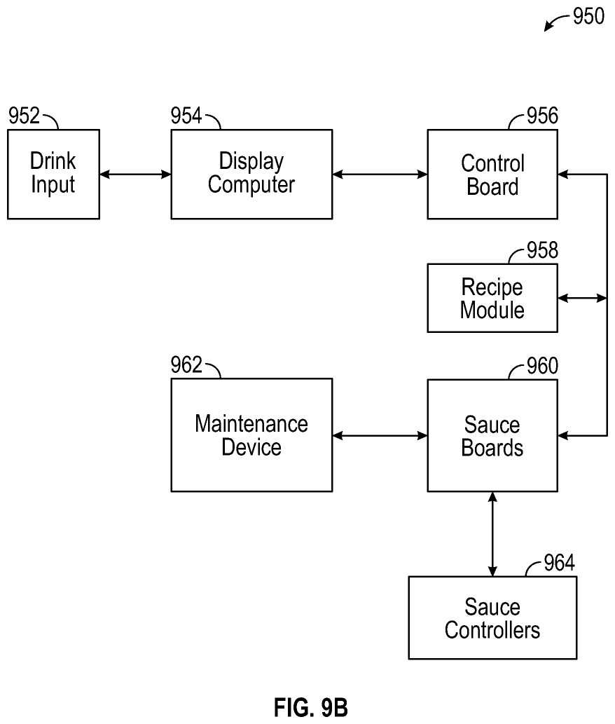

In FIGS. 9A-9B, illustrations of block diagrams are shown, according to various embodiments. In FIG. 9A, a block diagram is shown, according to one embodiment. A device 900 may include a controller 902, one or more processors 904, one or more memories 906, one or more inventory modules 908, one or more maintenance modules 910, one or more cleaning modules 912, one or more drink dispensing modules 914, one or more loyalty card modules 916, one or more cameras 918, one or more sensors 920, one or more flavor modules 922, one or more number of actuations modules 924, one or more displays 926, one or more display modules 928, one or more time/day modules 930, and/or one or more transceivers 932 and/or a recipe module 958 (see FIG. 9B).

In one example, the one or more inventory modules 908 may be utilize to track one or more materials to be reordered. For example, material for creating a drink has reached a predetermined inventory level, therefore, the system automatically and/or via an approval function orders more of the material. In another example, one or more pressure vessel has been utilized a predetermined number of times, therefore, a maintenance request is issued and/or warning report generated via the one or more maintenance modules 910. In another example, a predetermined number of drinks have been created which requires a cleaning procedure to be initiated via the one or more cleaning modules 912. In another example, one or more drink dispensing modules 914 may include one or more recipes for one or more drinks. In addition, the one or more loyalty card modules 916 may be utilized to track a client's purchase and generate one or more rewards and/or discounts. In another example, the one or more cameras 918 may be utilized to track system performance. In another example, the one or more sensors 920 may be utilized to track the performance of one or more devices and/or fluid and/or elements. In addition, the one or more flavor modules 922 may track data relating to one or more flavors. In addition, the one or more number of actuations modules 924 may track the number of times a device is utilized. Further, the one or more displays 926 may be utilized to display any data relating to this disclosure via the one or more display modules 928. In another example, the one or more time/day modules 930 may be utilized to track purchase and/or activity rate throughout the day. In addition, the one or more transceivers 932 may transmit any data in this disclosure to a remote device, control center, and/or any computing device. In addition, the recipe module 958 may include any data relating to any recipe.

In another example, syrup control and/or management can be enhanced because dumping and/or walk away can be tracked. For example, when a person buys a fountain drink that person may take a slip and if the taste is not correct that person may dump the contents of the container and refill with another flavor. This might indicate that the syrup ratio is out of range and/or another quality control issue. In addition, the person may just walk away and not purchase anything which could be an indication that the syrup ratio is out of range and/or another quality control issue.

FIG. 9B shows a drink delivery system 950 including a drink input device 952, a display computer 954, a control board 956, a recipe module 958, a sauce board 960, a maintenance device 962, and/or a sauce controller(s) 964. In one example, an order is input via a touch screen (e.g., 952) which is then displayed on a computer (e.g., 954). Further, a control board 956 communicates with the recipe module 958 to determine which control signals to transmit to the sauce board 960. The sauce board 960 transmits data to the sauce controller(s) 964 which transmits signals to various elements to produce the drink. In addition, the sauce board 960 transmits data to the maintenance device 962 to track data and/or initiate any maintenance activities (e.g., cleaning, repairing, etc.).

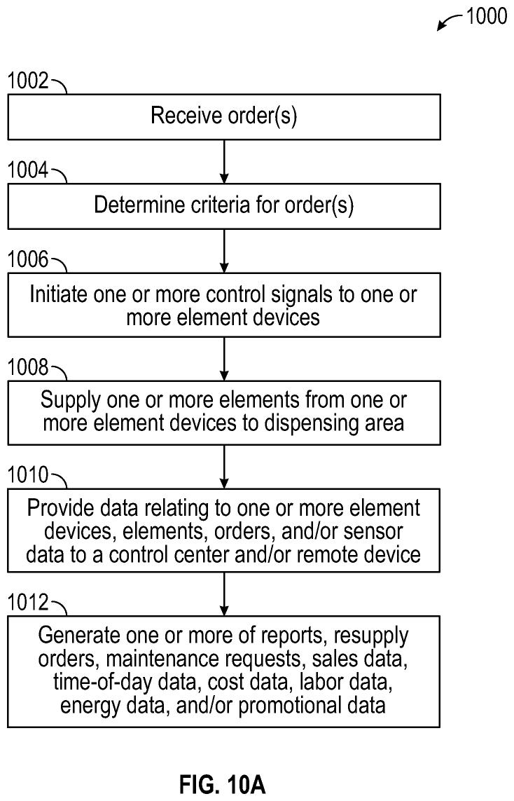

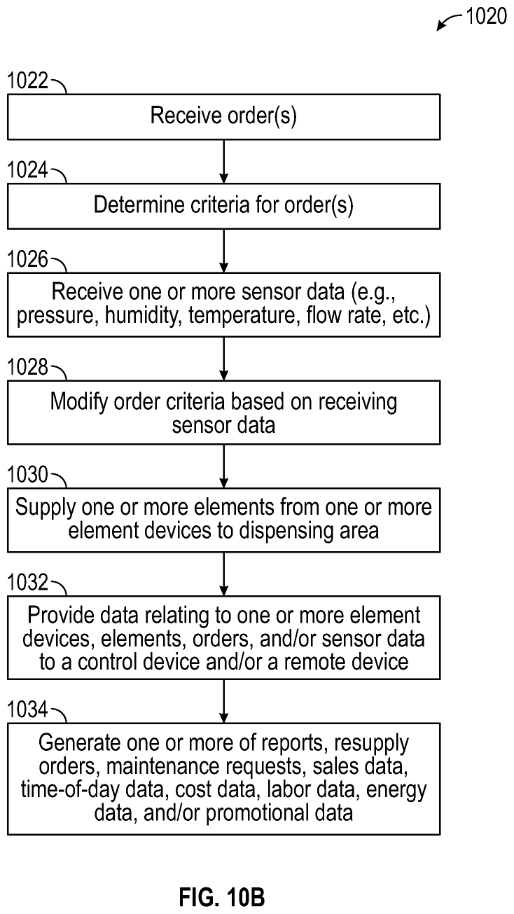

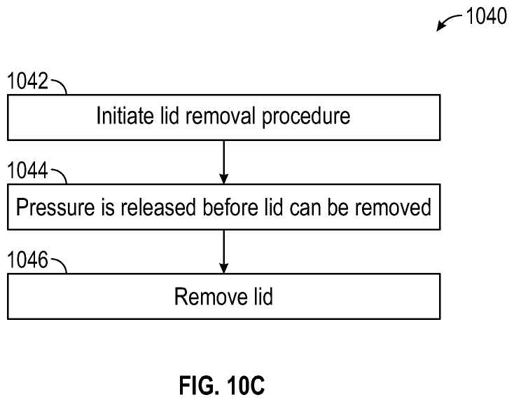

In FIGS. 10A-10C, illustrations of flowcharts are shown, according to various embodiments. In FIG. 10A, a method 1000 may include receiving order(s) (step 1002). The method 1000 may include determining criteria for the order(s) (step 1004). The method 1000 may include initiating one or more control signals to one or more element devices (step 1006). The method 1000 may include supplying one or more elements from one or more element devices to a dispensing area (step 1008). The method 1000 may include providing data relating to one or more element devices, elements, orders, and/or sensor data to a control center and/or remote device (step 1010). The method 1000 may include generating one or more reports, resupply orders, maintenance requests, sales data, time-of-day data, cost data, labor data, energy data, and/or promotional data to one or more of a control device, computing device, and/or remote computing device (step 1012).

In FIG. 10B, a method 1020 may include receiving order(s) (step 1022). The method 1020 may include determining criteria for the order(s) (step 1024). The method 1020 may include receiving one or more sensor data (e.g., pressure, humidity, temperature, flowrate, etc.) (step 1026). The method 1020 may include modifying order criteria based on the received sensor data (step 1028). The method 1020 may include initiating one or more control signals to one or more element devices (see FIG. 10A-step 1006). The method 1020 may include supplying one or more elements from one or more element devices to a dispensing area (step 1030). The method 1020 may include providing data relating to one or more element devices, elements, orders, and/or sensor data to a control center and/or remote device (step 1032). The method 1020 may include generating one or more reports, resupply orders, maintenance requests, sales data, time-of-day data, cost data, labor data, energy data, and/or promotional data to one or more of a control device, computing device, and/or remote computing device (step 1034).

In FIG. 10C, a method 1040 may include initiating a LID removal procedure (step 1042). The method 1040 may include pressure being released before LID can be removed (step 1044). The method 1040 may include removing the LID (step 1046).

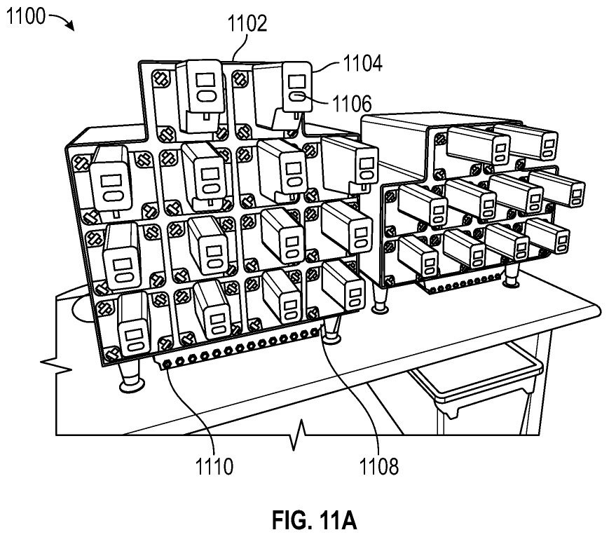

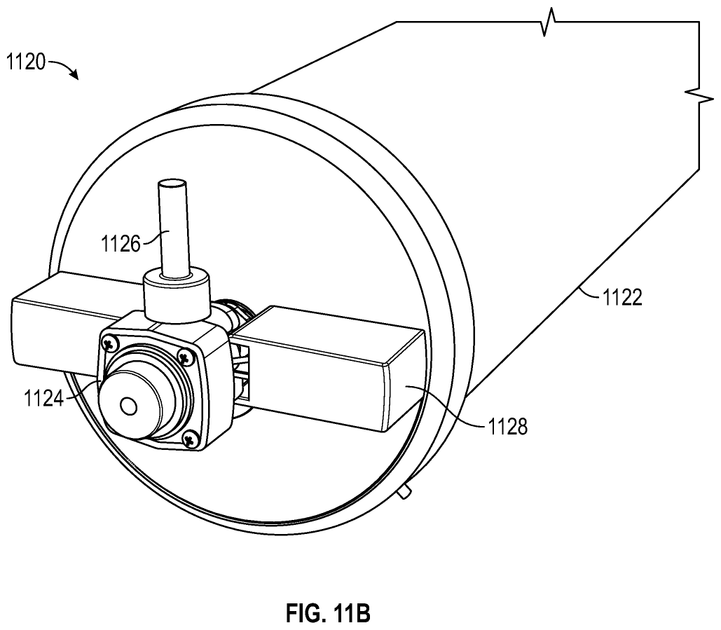

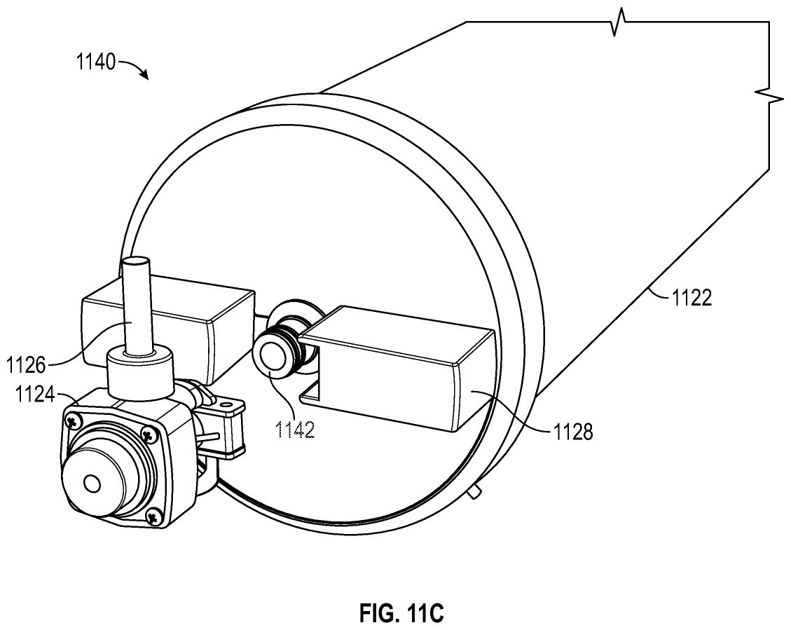

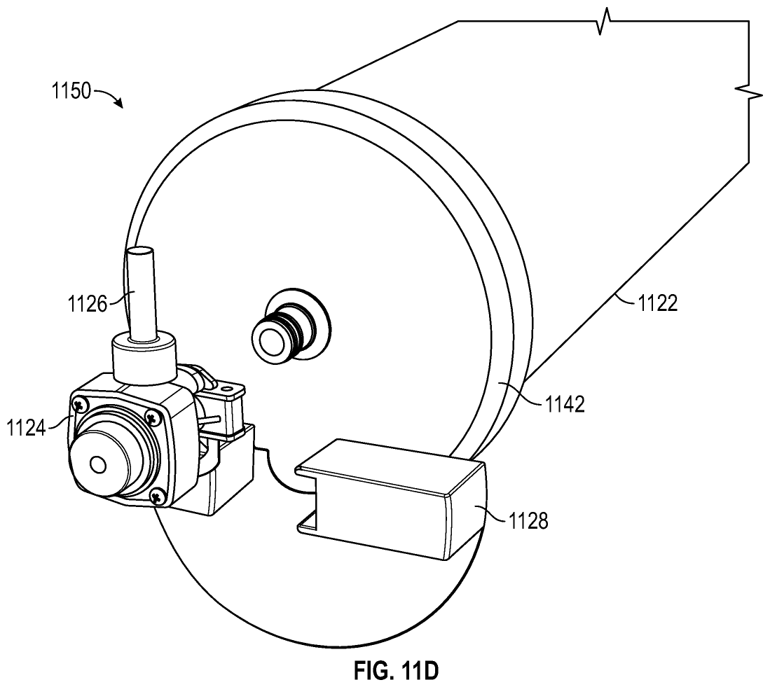

In FIGS. 11A-11D, illustrations of the utilization of a toggling device with the dispensing system are shown, according to various embodiments. FIG. 11A shows a dispensing system 1100 with a housing 1102 containing one or more pressure vessels, a dispensing device 1104, a dispensing button 1106, a plurality of toggles 1108 with one or more toggles 1110. In one example, a toggle relief system where a canister can be depressurized using a toggle switch 1110. The toggle switch 1110 is mechanical and is connected to the canister (e.g., pressure vessel) that is under pressure. When the toggle switch 1110 is in the closed position the pressure vessel operates normally; however, when the toggle switch 1110 is released (e.g., opened) the pressure is released from the pressure vessel and the lid can be removed.

FIG. 11B shows a pressure vessel 1120 with a pressure vessel body 1122, a toggle switch 1124, a lid 1126, and a support structure 1128. In FIG. 11C, a fitting 1142 is shown which can connect the dispensing area to the bag in a pressure vessel 1140. In FIG. 11D, a pressure vessel 1150 includes the pressure vessel body 1122, the toggle 1124, the lid 1126, the support structure 1128, and the fitting 1142. In one example, a reed switch can be used to automatically depressurize the pressure vessel when the lid is removed. In this instance the lid (and/or a feature of the lid) would be turned to a position A, which would cause the lid to lose contact with the REED switch, which would then cause the relief solenoid and/or relief device to open depressurizing the pressure vessel. In another example, a mechanical method could be used to release pressure slowly as the lid is removed. In one example, a stepped feature in the lid were turning to position A causes a pathway to open for a depressurizing function to be initiated on the pressure vessel. In another example, with the removable canister/cartridge, the pressure relief can happen automatically when the connection between the cartridge/canister and the fluid source is lost. By utilizing a small cartridge/canister with a small input orifice for the fluid, then by disconnecting the cartridge/canister from the fluid source will automatically cause the canister (e.g., pressure vessel) to depressurize.

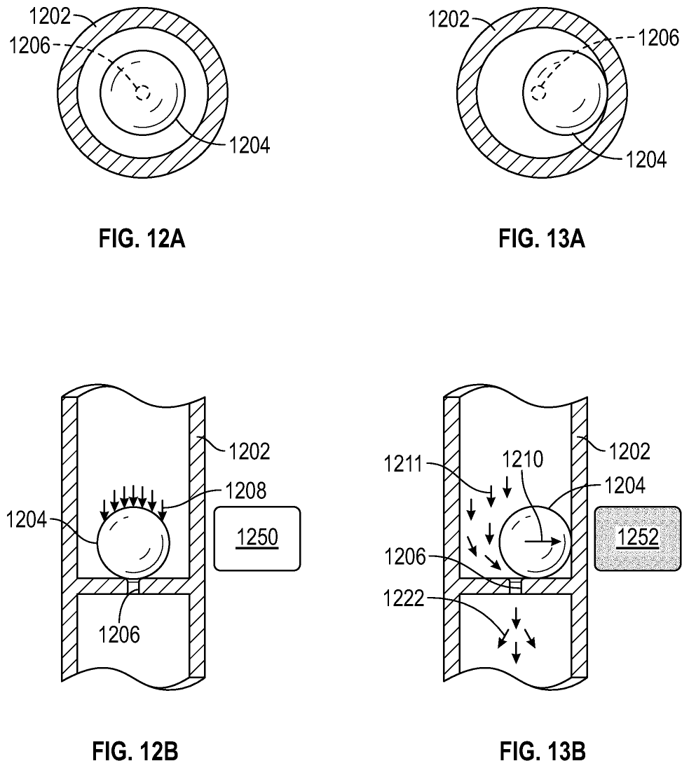

In FIGS. 12A-13B, illustrations of a blocking device and a movement device are shown, according to various embodiments. FIG. 12A ad FIG. 12B illustrate a first embodiment for the valve in a valve closed position. FIG. 12A illustrates a top sectional view, whereas FIG. 12B illustrates a side sectional view for the first embodiment in the closed position. As seen in these two Figures a Ball covers/closed an orifice opening, with a portion of the Ball extending into the orifice opening. With the Ball closing the orifice opening, fluid is prevented from flowing through the pipe, tube, chamber, hose or other type if fluid conduit (all collectively referred to as “Conduit”). As seen in FIG. 12B a magnetic coupling located on an external/outside of the Conduit is out of magnetic range of the metal Ball and thus is unable to control the movement or position of the Ball. The Ball is therefore forced in the shown sealing position with respect to the orifice opening by the pressure flow within the Conduit. Preferably, the Ball is constructed from a magnetic, metallic and/or rigid material and all are considered within the scope of the disclosure.

FIG. 13A and FIG. 13B illustrate a first embodiment for the valve in a valve open position. FIG. 13A illustrates a top sectional view, whereas FIG. 13B illustrates a side sectional view for the first embodiment in the open position. As seen in these two Figures, the magnetic coupling is moved within magnetic range of the Ball, which causes the Ball to pulled towards the externally located magnetic coupling and no longer sealing the orifice opening, thus, allowing fluid flow through the orifice opening.

In FIG. 12A, an illustration of a ball functionality is shown, according to one embodiment. In one example, a dispensing element 1200 may include a conduit 1202, a blocking element 1204, and a dispensing element 1206 (e.g., orifice). In various examples, the conduit 1202 may be a hose, a pipe, and/or any other element with an external surface and an internal surface which allows for the passage of one or more fluids and/or one or more gases. In various examples, the blocking element 1204 may be a ball, a block, and/or any other element that stops the passage of one or more fluids and/or one or more gases when the blocking element is in one or more positions relative to the dispensing element. In this example shown in FIG. 12A, the blocking element 1204 is positioned over the dispensing element 1206 which stops the passage of one or more fluids and/or one or more gases which can be seen in FIG. 12B. In the example shown in FIG. 12B, the blocking element 1204 stops a fluid flow because the flow (e.g., line PSI) is putting pressure 1208 on the blocking element 1204 which creates a seal between the blocking element 1204 and the dispensing element 1206 (the dispensing element 1206 in this example is a hole and/or the orifice opening(s)). In this example, the pressure 1208 is all around the blocking element but is strongest when it is parallel with the dispensing element. In one example, a movement device 1250 is a magnet or an electro-magnet.

In FIG. 13A, another illustration of a ball functionality is shown, according to one embodiment. In this example, the blocking element 1204 has moved to a second position relative to the dispensing element 1206. In this example, the movement device 1252 is on which allows the movement device 1252 to interact with the blocking element as shown in FIG. 13B. The movement device 1252 (e.g., a magnet) has caused the blocking element 204 (e.g., a Ferro-magnetic material and/or a metal ball) to move in a first direction 1210 towards the movement device 1220 which allows for a first fluid flow 1211 to move towards the dispensing element 1206 and a second fluid flow 1222 through the dispensing element 1206 until the movement device is turned off which causes the blocking element to move back to a position to block the flow of fluids through the dispensing element 1206 as shown in FIG. 12B.

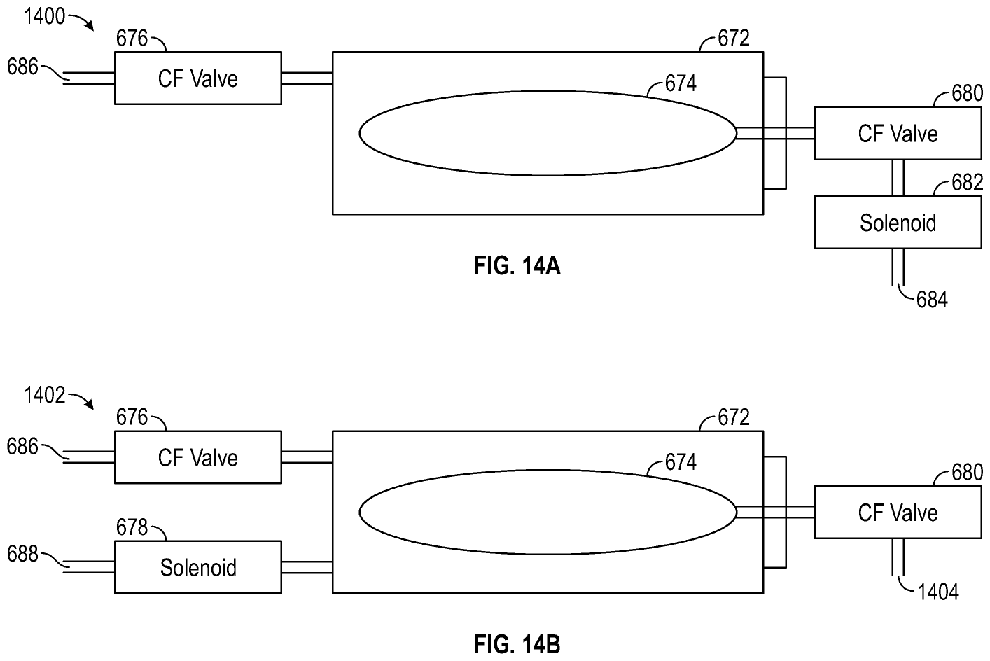

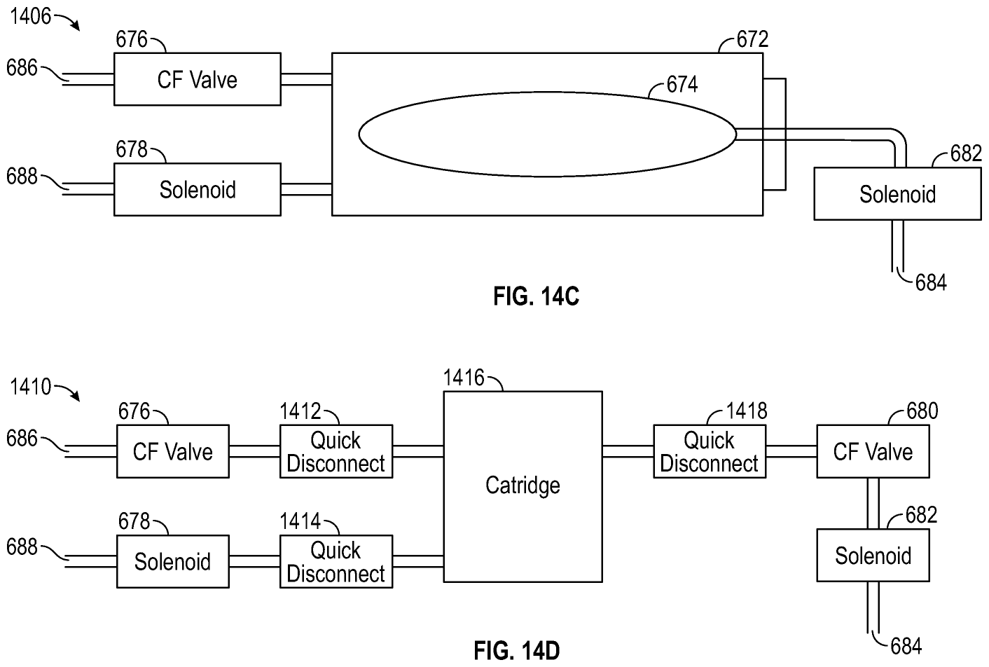

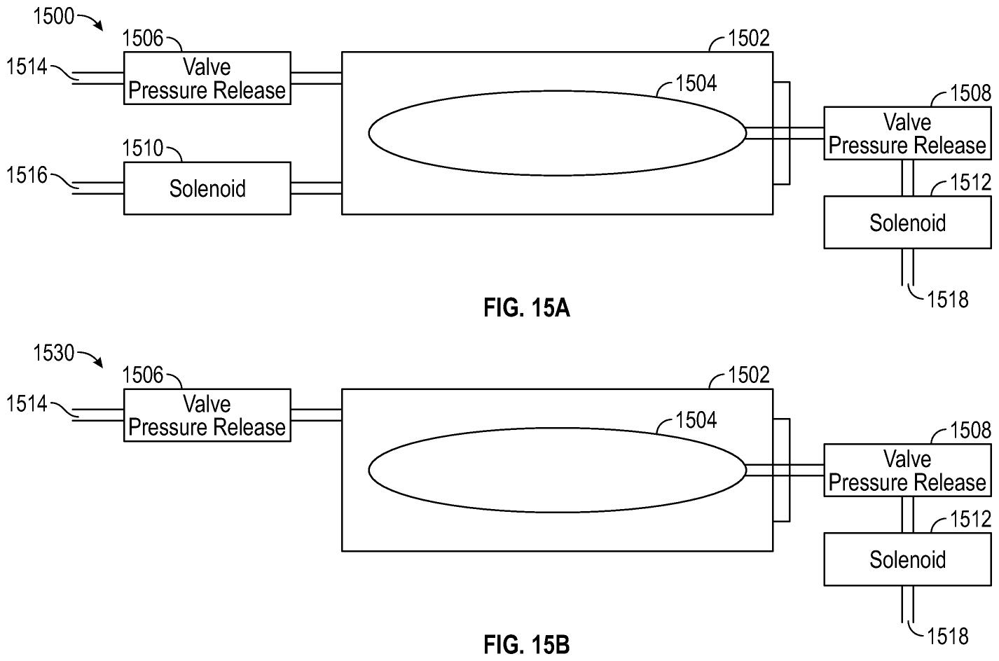

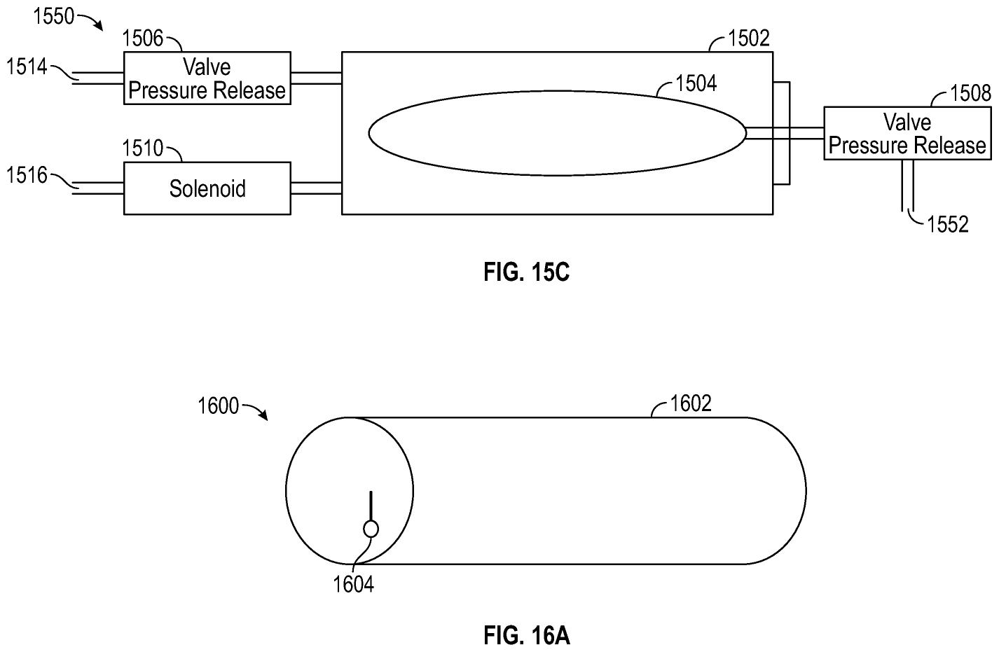

In FIGS. 14A-15C, illustrations of the pressurized container dispensing system are shown, according to various embodiments. FIG. 14A shows a pressurized dispensing system 1400 including the pressure vessel 672, the flexible bag 674, the first CF Valve 676 with a solenoid (e.g., a CFiVe valve), the second CF Valve 680, the third solenoid 682, the outlet area 684 (e.g., dispensing area), and/or the pressure input area 686. In this example, the dispensing system 1400 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 27 PSI) and the second CF Valve 680 on the outlet of the canister operates at an operating pressure of Y (e.g., 14 PSI). In this example, the operating pressure of Y is less than the operating pressure of X. In one example, the first CF Valve 676 with a solenoid is opened and the canister is filled to the operating pressure X (e.g., 27 PSI) and as soon as the pressure in the pressure vessel 672 exceeds the operating pressure Y (e.g., 14 PSI) the second CF Valve 680 will open and dispense one or more elements (e.g., fluids, gas, etc.) from the flexible bag 674. In various examples, the second CF Valve 680 may have a throttle pin and/or no throttle pin depending on the flow rate to be achieved by the one or more elements. In another example, the first CF Valve 676 with a solenoid will open for 0.83 seconds to dispense 0.42 ounces of a fluid at 27 PSI, once the pressure vessel 672 fluid (e.g., fluid in bag) exceeds 15 PSI the second CF Valve 680 will open and dispense the one or more elements.

FIG. 14B shows a pressurized dispensing system 1402 including includes the pressure vessel 672, the flexible bag 674, the first CF Valve 676 with a solenoid (e.g., a CFiVe valve), the second solenoid 678, the second CF Valve 680, the outlet area 684 (e.g., dispensing area), the pressure input area 686, and/or the pressure outlet area 688. In this example, the dispensing system 1402 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 25 PSI) and the second CF Valve 680 on the outlet of the canister operates at an operating pressure of Y (e.g., 13 PSI). In this example, the operating pressure of Y is less than the operating pressure of X. In addition, the second solenoid 678 acts to depressurize the pressure vessel 672 when the dispensing operation is completed. In one example, the first CF Valve 676 with a solenoid is opened and the canister is filled to the operating pressure X (e.g., 25 PSI) and as soon as the pressure in the pressure vessel 672 exceeds the operating pressure Y (e.g., 13 PSI) the second CF Valve 680 will open and dispense one or more elements (e.g., fluids, gas, etc.) from the flexible bag 674. In this example, when the appropriate amount of the one or more elements is dispensed, the second solenoid 678 will open to partially relieve the pressure from the pressure vessel 672 to under the threshold of the second CF Valve 680 operating pressure of Y. In various examples, the second CF Valve 680 may have a throttle pin and/or no throttle pin depending on the flow rate to be achieved by the one or more elements. In another example, the second solenoid 678 may be controlled with a set time to depressurize and/or with a pressure sensor to depressurize to a set pressure. There are many benefits to this dispensing system 1402. For example, there are no electronics or electrical connections on the lid/cover of the pressure vessel 672 (which must be removed to replace the flexible bag 674 and to be cleaned). In another example, the first CF Valve 676 with a solenoid will open for 0.75 seconds to dispense 0.5 ounces of a fluid at 25 PSI, once the pressure vessel 672 fluid (e.g., fluid in bag) exceeds 13 PSI the second CF Valve 680 will open and dispense the one or more elements. Once the first CF Valve 676 with a solenoid closes, the second solenoid 678 will open for 0.6 seconds to relieve the pressure of fluid (e.g., fluid outside of the flexible bag 674) in the pressure vessel 672 to 11 PSI and the second CF Valve 680 will close which stops the dispensing of the one or more elements (e.g., liquid, gas, etc.). In another example, the second solenoid 678 can be controlled with a pressure sensor so that the second solenoid 678 opens and then closes when the pressure in the pressure vessel 672 reaches a targeted closing pressure (e.g., 11 PSI in the above-referenced example).

In FIG. 14C. a dispensing system 1406 includes the pressure vessel 672, the flexible bag 674, the first CF Valve 676 with a solenoid (e.g., a CFiVe valve), the second solenoid 678, the third solenoid 682, the outlet area 684 (e.g., dispensing area), the pressure input area 686, and/or the pressure outlet area 688. In this example, the dispensing system 1406 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 28 PSI) and the outlet of the canister operates at an operating pressure of Y (e.g., 16 PSI). In this example, the operating pressure of Y is less than the operating pressure of X. In addition, the second solenoid 678 acts to depressurize the pressure vessel 672 when the dispensing operation is completed. In one example, the first CF Valve 676 with a solenoid is opened and the canister is filled to the operating pressure X (e.g., 28 PSI) and as soon as the pressure in the pressure vessel 672 exceeds the operating pressure Y (e.g., 16 PSI) the third solenoid 682 will open and dispense one or more elements (e.g., fluids, gas, etc.) from the flexible bag 674. In this example, when the appropriate amount of the one or more elements is dispensed, the second solenoid 678 will open to partially relieve the pressure from the pressure vessel 672 to under the threshold operating pressure of Y. In another example, the second solenoid 678 may be controlled with a set time to depressurize and/or with a pressure sensor to depressurize to a set pressure. There are many benefits to this dispensing system 1406. For example, there are no electronics or electrical connections on the lid/cover of the pressure vessel 672 (which must be removed to replace the flexible bag 674 and to be cleaned). In another example, the first CF Valve 676 with a solenoid will open for 0.63 seconds to dispense 0.75 ounces of a fluid at 28 PSI, once the pressure vessel 672 fluid (e.g., fluid in bag) exceeds 16 PSI the third solenoid 682 will open and dispense the one or more elements. Once the first CF Valve 676 with a solenoid closes, the second solenoid 678 will open for 0.9 seconds to relieve the pressure of fluid (e.g., fluid outside of the flexible bag 674) in the pressure vessel 672 to 14 PSI and the second CF Valve 680 will close which stops the dispensing of the one or more elements (e.g., liquid, gas, etc.). In another example, the second solenoid 678 can be controlled with a pressure sensor so that the second solenoid 678 opens and then closes when the pressure in the pressure vessel 672 reaches a targeted closing pressure (e.g., 14 PSI in the above-referenced example).

In FIG. 14D. a dispensing system 1410 includes a first disconnect device 1412, a second disconnect device 1414, a cartridge 1416 (e.g., filled with flavors, liquids, elements, ingredients, etc.), a third disconnect device 1418, the first CF Valve 676 with a solenoid (e.g., a CFiVe valve), the second solenoid 678, the second CF Valve 680, the third solenoid 682, the outlet area 684 (e.g., dispensing area), the pressure input area 686, and/or the pressure outlet area 688. In this example, the dispensing system 1410 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the cartridge 1416 and is controlled by the inbound solenoid at an operating pressure of X (e.g., 27 PSI) and the second CF Valve 680 on the outlet of the canister operates at an operating pressure of Y (e.g., 14 PSI). In this example, the operating pressure of Y is less than the operating pressure of X. In addition, the second solenoid 678 acts to depressurize the cartridge 1416 when the dispensing operation is completed. In one example, the first CF Valve 676 with a solenoid is opened and the cartridge 1416 is filled and/or pressure applied to the cartridge to the operating pressure X (e.g., 27 PSI) and as soon as the pressure exceeds the operating pressure Y (e.g., 14 PSI) the second CF Valve 680 will open and dispense one or more elements (e.g., fluids, gas, etc.) from the cartridge 1416. In this example, when the appropriate amount of the one or more elements is dispensed, the second solenoid 678 will open to partially relieve the pressure from the cartridge 1416 to under the threshold of the second CF Valve 680 operating pressure of Y. In various examples, the second CF Valve 680 may have a throttle pin and/or no throttle pin depending on the flow rate to be achieved by the one or more elements. In another example, the second solenoid 678 may be controlled with a set time to depressurize and/or with a pressure sensor to depressurize to a set pressure. There are many benefits to this dispensing system 1410. For example, there are no electronics or electrical connections on the lid/cover of the pressure vessel 672 (which must be removed to replace the flexible bag 674 and to be cleaned). In another example, the first CF Valve 676 with a solenoid will open for 0.83 seconds to dispense 0.42 ounces of a fluid at 27 PSI, once the cartridge 1416 fluid (e.g., fluid in cartridge) exceeds 15 PSI the second CF Valve 680 will open and dispense the one or more elements. Once the first CF Valve 676 with a solenoid closes, the second solenoid 678 will open for 0.7 seconds to relieve the pressure on the cartridge 1416 to 12 PSI and the second CF Valve 680 will close which stops the dispensing of the one or more elements (e.g., liquid, gas, etc.). In another example, the second solenoid 678 can be controlled with a pressure sensor so that the second solenoid 678 opens and then closes when the pressure in the cartridge 1416 reaches a targeted closing pressure (e.g., 12 PSI in the above-referenced example).

In FIG. 15A, a dispensing system 1500 includes a pressure vessel 1502, a flexible bag 1504, a first pressure release valve, a second solenoid 1510, a second pressure release valve 1508, a third solenoid 1512, an outlet area 1518 (e.g., dispensing area), a pressure input area 1514, and/or a pressure outlet area 1516. In FIG. 15B, a dispensing system 1530 includes the pressure vessel 1502, the flexible bag 1504, the first pressure release valve 1506, the second pressure release valve 1508, the third solenoid 1512, the outlet area 1518 (e.g., dispensing area), and/or the pressure input area 1514. In FIG. 15B, a dispensing system 1550 includes the pressure vessel 1502, the flexible bag 1504, the first pressure release valve 1506, the second solenoid 1510, the second pressure release valve 1508, the outlet area 1518 (e.g., dispensing area), the pressure input area 1514, and/or the pressure outlet area 1516.

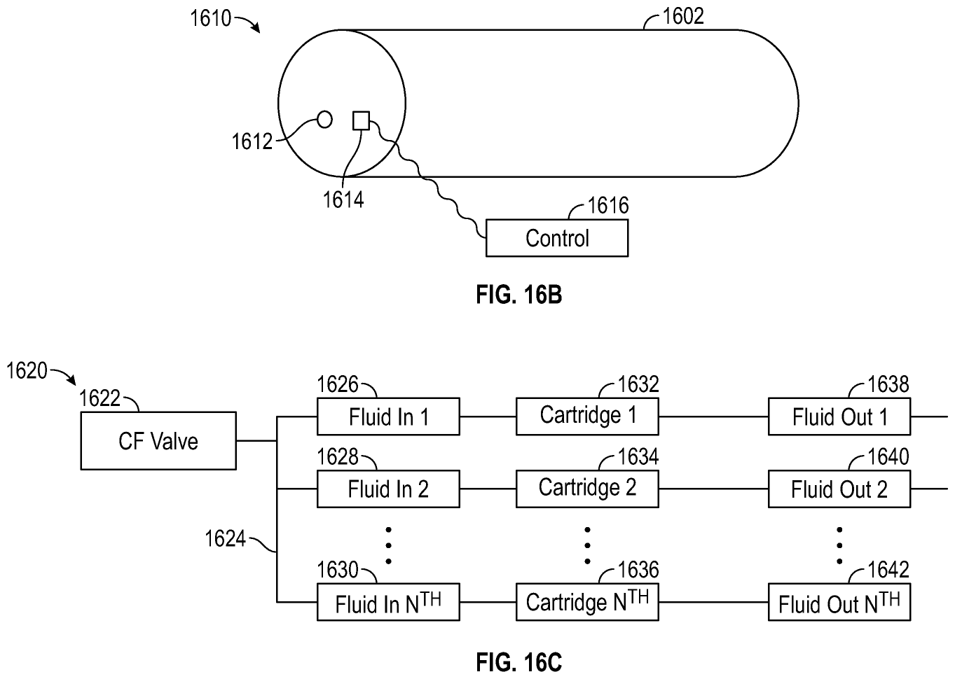

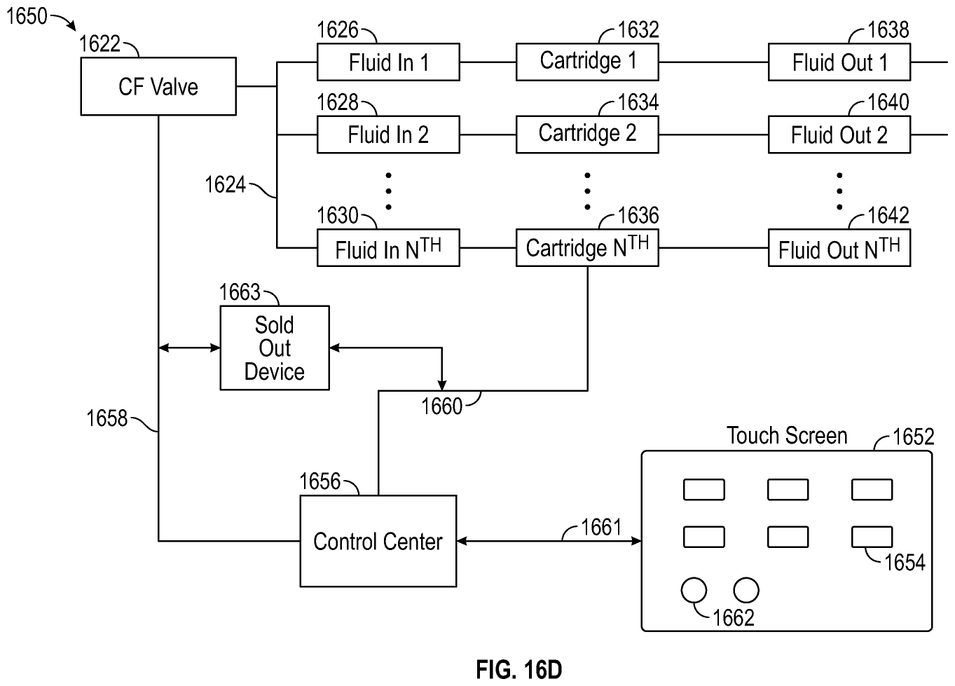

In FIGS. 16A-16B, illustrations of the pressurized release devices are shown, according to various embodiments. FIG. 16A shows an illustration 1600 of a pressure vessel 1602 with a toggle switch 1604 to release pressure in the pressure vessel 1602. FIG. 16B shows an illustration 1610 of the pressure vessel 1602 with a blocking device 1612, a movement device 1614, and a controller 1616. In this example, the movement device 1614 acts on the blocking device 1612 to move the blocking device from a closed position (where pressure is maintained in the pressure vessel 1602) to an open position (where the pressure is decreased in the pressure vessel 1602).

In FIGS. 16C-16D, illustrations of the customizable drink dispensing system are shown, according to various embodiments. In FIG. 16C, a single CF Valve 1622 is providing a pressure function to a manifold 1624 of cartridges and/or pressure vessels. For example, the manifold 1624 is providing a first fluid flow 1626 to a first cartridge 1632 which generates a first fluid out 1638. In addition, the manifold 1624 being fed by the CF Valve 1622 provides a second fluid flow 1628 to a second cartridge 1634 which generates a second fluid out 1640. Further, the manifold 1624 provides an Nth fluid flow 1630 to an Nth cartridge 1636 which generates an Nth fluid out 1642. In FIG. 16D, the single CF Valve 1622 is providing a pressure function to the manifold 1624 of cartridges and/or pressure vessels. For example, the manifold 1624 is providing the first fluid flow 1626 to the first cartridge 1632 which generates the first fluid out 1638. In addition, the manifold 1624 being fed by the CF Valve 1622 provides the second fluid flow 1628 to the second cartridge 1634 which generates the second fluid out 1640. Further, the manifold 1624 provides the Nth fluid flow 1630 to the Nth cartridge 1636 which generates the Nth fluid out 1642. In addition, the system may include a touch screen 1652 with one or more buttons 1654 or knobs 1662. The touch screen 1652 may communicate with a control center 1656 to transmit one or more command signals to one or more cartridges and/or pressuring vessels, and/or CF Valves 1622 via one or more communication links (e.g., 1658, 1660, and 1661). In addition, a sold-out device 1663 may be utilized.

In FIGS. 17A-17B, illustrations of a cartridge are shown, according to various embodiments. In FIG. 17A, an illustration of a CF Cartridge 1700 is shown, according to one embodiment. The cartridge CF Valve 1700 includes a throttle pin 1702, a body 1704, a body O-Ring 1718, a top retainer 1706, a diaphragm 1708, a bottom retainer 1710, a spring 1712, a spring cap 1714, and a spring cap O-Ring 1716. The throttle pin 1702 may be stainless steel or other material with a barbed shank and mushroom shape head. The throttle pin throttles flow of fluid through the inlet orifice. The body 1704 (or the CF Valve body and/or the cartridge CF Valve body) may be molded plastic forming the inlet passage. The diaphragm 1708 (and/or the diaphragm chamber) is a 360-degree outlet passage and diaphragm sealing surface. The body O-Ring 1718 is a rubber that seals the fluid functioning part of the cartridge from the housing. The top retainer 1706 is a plastic which forms the top half of the diaphragm assembly where the diaphragm 1708 is sandwiched between the two retainers (e.g., top retainer 1706 and the bottom retainer 1710) to form a seal. There is a molded cavity in the upper retainer (e.g., top retainer 1706) that positions the barbed shank of the throttle pin 1702. The cavity may be machined and/or any other process of manufacturing a cavity.

The diaphragm 1708 is a flexible rubber (and/or any other flexible material) shaped to form a seal between the fluid section and the dry section of the spring cavity. The flex of the diaphragm 1708 allows the throttle pin 1702 to move in response to the spring pressure and inlet pressure thus modulating the fluid flow through the inlet orifice. The bottom retainer 1710 is a plastic part which may be welded (and/or press fitted, and/or any other attachment procedure (e.g., glued, stamped, etc.) to the upper retainer (e.g., top retainer 1706) to form the diaphragm assembly. The bottom retainer 1710 also positions the spring 1712 in the spring cap 1714. The spring 1712 is stainless steel (and/or other similar material—non corrosive material—the material can be a corrosive material also since the area is dry) and serves to keep the diaphragm 1708 seated against the sealing ring of the body 1704 until there is sufficient input pressure to compress the spring opening the valve for normal operation. As the throttle pin 1702 is fastened (could sit on top of—further the spring may not be fastened buy sits against cap and retainer) to the diaphragm assembly, when the inlet pressure depresses the diaphragm 1708/spring 1712 the throttle pin 1702 closes the inlet orifice reducing the flow/pressure. There is continuous movement of the spring 1712, the diaphragm assembly and the throttle pin 1702 as the valve modulates and maintains the preset fixed operating pressure.

The spring cap 1714 is usually plastic but can be any material stiff enough to mitigate any movement of the material that would change the length of the spring cap cavity. The length of the cavity is critical because the spring 1712 must be preset and/or compressed to the operating load before the cartridge CF Valve 1700 is put into operating. It should be noted that the spring cap 1714 creates the seal by compressing the diaphragm 1708 to the body 1704. The rubber cap “0” ring is to form a seal so the passage of the fluid from the body 1704 through the housing cannot leak out around the spring cap 1714.

In FIG. 17B, another illustration of the cartridge CF Valve 1700 is shown, according to one embodiment. In this example, the cartridge CF Valve 1700 is shown assembled.

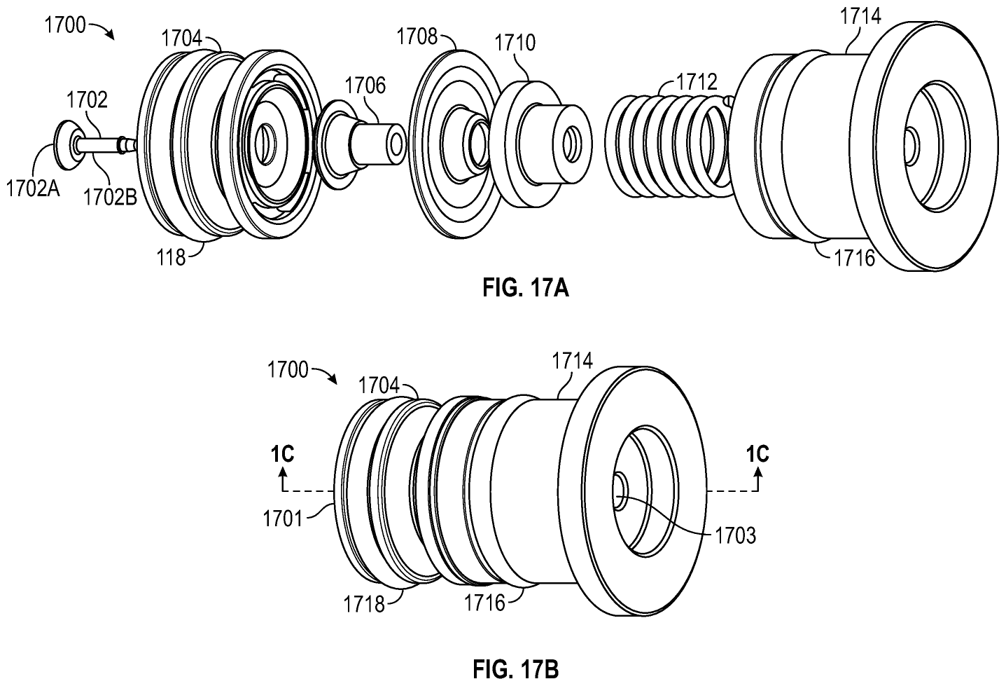

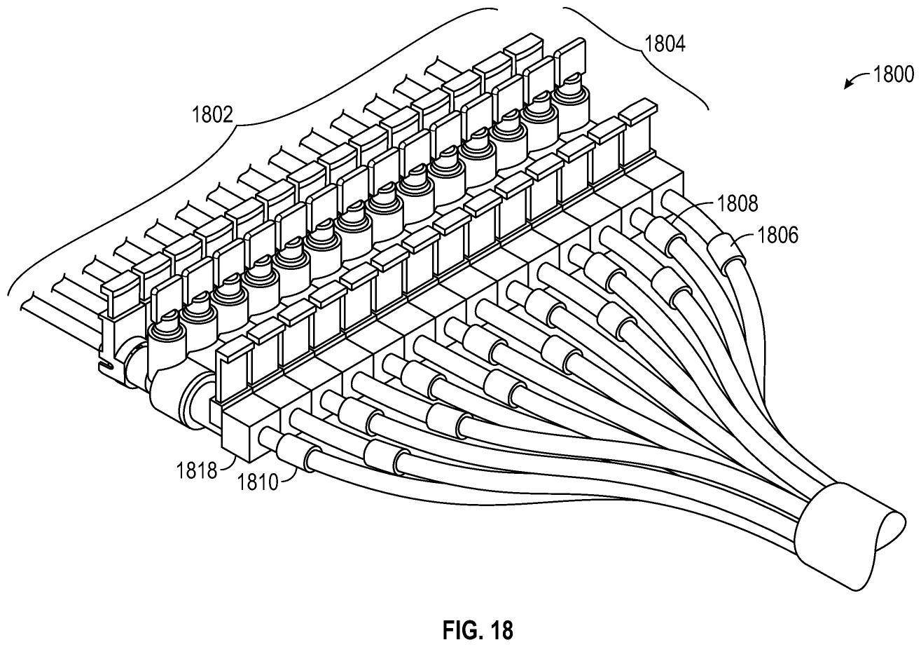

FIG. 18 is an illustration of utilizing the length of a tube for flowrate control, according to one embodiment. In FIG. 18, an illustration of a CF Valve device is shown, according to one embodiment. The CF Valve device may include one or more fluid or gas sources 1802 (e.g., water, carbon, carbonated water, nitrogen, syrup 1, syrup 2, . . . , syrup N), a CF Valve manifold 1804, one or more solenoids 1818, a first CF Valve 1806, a second CF Valve 1808, and/or an Nth CF Valve 1810. In one example, the one or more solenoids 1818 are not present. Further, in various examples, the one or more CF Valves (e.g., the first CF Valve 1806, the second CF Valve 1808, and/or the Nth CF Valve 1810) are staggered or separate in the tubing of the hose(s). In another example, sets of CF Valves may be staggered or separated. For example, a first group or set of CF Valves may be located at a position X of their respective tube or hose (with a first flow rate based on the position X) while a second group of set of CF Valves may be located at a position Y of their respective tube or hose (with a second flow rate based on the position Y) while an Nth group or set of CF Valves may be located at a position Z of their respective tube or hose (with a first flow rate based on the position Z).

FIG. 19 shows an illustration 1900 of a lid 1902 with a CF Valve 1904 attached to the lid 1902, according to one embodiment.

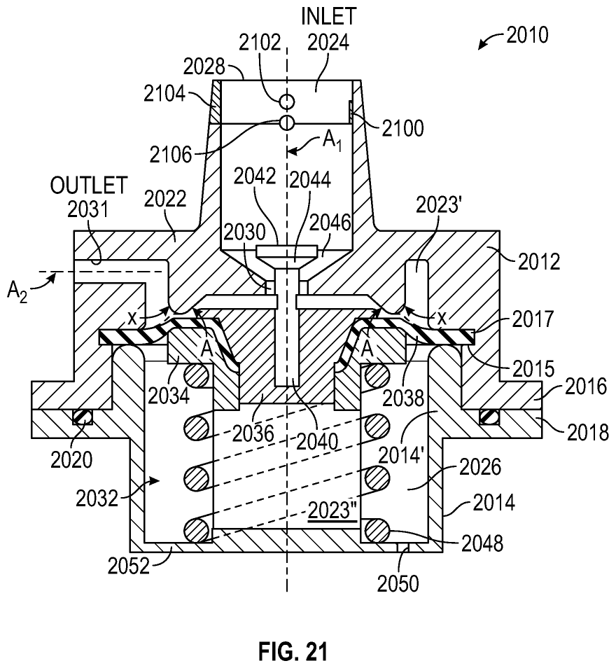

FIGS. 20-21 are illustrations of a CF Valve, according to various embodiments. With reference to FIGS. 20-21, a regulating valve in accordance with the present disclosure is generally depicted at 2010. The valve includes an outer housing having a cap 2012 joined to a cup-shaped base 2014 at mating exterior flanges 2016, 2018.

The housing is internally subdivided by a barrier wall 2022 into a head section 2024 and a base section 2026. An inlet 2028 in the cap 2012 is adapted to be connected to a fluid supply (not shown) having a pressure that can vary from below to above a threshold level. The inlet 2028 and a central port 2030 in the barrier wall 2022 are preferably aligned coaxially with a central axis A1 of the valve. An outlet port 2031 is provided in the cap 2012, and may be aligned on a second axis A2 transverse to the first axis A1. Although the axis A2 is shown at 90° with respect to axis A1, it will be understood that axis A2 may be oriented at other angles with respect to axis A1 in order to suit various applications of the valve.

A modulating assembly 2032 internally subdivides the base section into a fluid chamber 2023′ segregated from a spring chamber 2023″. The modulating assembly serves to prevent fluid flow through the valve when the fluid pressure at the inlet 2028 is below the threshold pressure. When the fluid pressure at the inlet exceeds the threshold pressure, the modulating assembly serves to accommodate fluid flow from the head section 2024 through port 2030 into fluid chamber 2023′ and from there through outlet port 2031 at a substantially constant outlet pressure and flow rate. Either the outlet port 2031 or a downstream orifice or flow restrictor (not shown) serves to develop a back pressure in fluid chamber 2023′.

The modulating assembly 2032 includes a piston comprised of a hollow shell 2034 and a central plug 2036. The piston is supported for movement in opposite directions along axis A1 by a flexible annular diaphragm 2038. The inner periphery of the diaphragm is captured between the shell 2034 and plug 2036. The cup shaped base 2014 has a cylindrical wall segment 2014′ received within the cap 2012. The outer periphery of the diaphragm is captured between an upper rim 2015 of the wall segment 2014′ and an inwardly projecting interior ledge 2017 on the cap. The outer periphery of the diaphragm thus serves as an effective seal between the cap 2012 and base 2014.

A stem 2040 on the piston plug 2036 projects through the port 2030 into the head section 2024. An enlarged head 2042 on the stem has a tapered underside 2044 that coacts with a tapered surface 2046 of the barrier wall to modulate the size of the flow path through the port 2030 as an inverse function of the varying fluid pressure in the input section, with the result being to deliver fluid to the outlet 2031 at a substantially constant pressure and flow rate.

A compression spring 2048 in the spring chamber 2023″ is captured between an underside surface of shell 2034 and the bottom wall 2052 of the housing base 2014. The spring urges the modulating assembly 2032 towards the barrier wall 2022. When the fluid inlet pressure is below the threshold pressure, spring 2048 serves to urge the diaphragm 2038 against a sealing ring 2049 on the underside of the barrier wall 2022, thus preventing fluid through flow from the head section 2024 via port 2030 and fluid chamber 2023′ to the outlet 2031. As the fluid inlet pressure exceeds the threshold pressure, the resilient closure force of spring 2048 is overcome, allowing the modulating assembly to move away from the sealing ring 2049, and allowing the modulating function of the coacting tapered surfaces 2044, 2046 to commence. An opening 2050 in the bottom wall 2052 serves to vent the volume beneath diaphragm 2038 to the surrounding atmosphere.

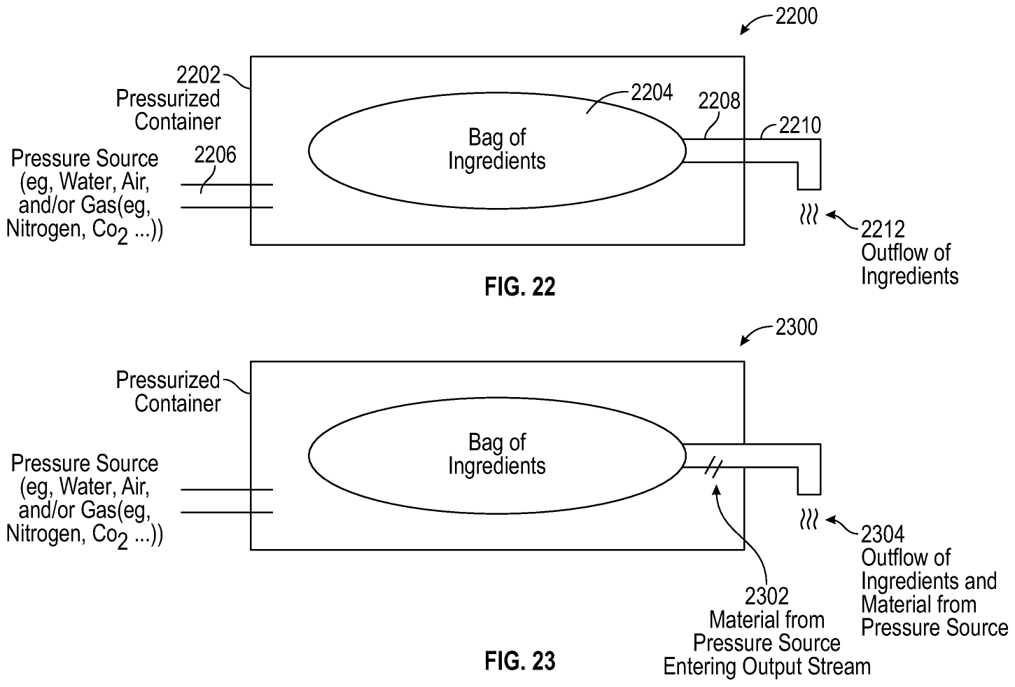

In FIG. 22, an illustration of a pressurized container is shown, according to one embodiment. In one example, a dispensing device 2200 may include a pressurized container 2202, a bag of ingredients 2204 (and/or pouch and/or any other containment apparatus), a pressure source 2206 (e.g., air, water, any gas (e.g., nitrogen, CO₂, etc.) and/or any other pressurizing substance), an inside the pressurized container outlet tube 2208, an outside the pressurized container outlet area 2210, and a dispensing area 2212. In this example, the pressurized source 2206 applies pressure to pressurize the pressurized container 2202. When the pressure reaches a threshold pressure the bag of ingredients expels one or more elements into the inside the pressurized container outlet tube 2208 which then travels to the outside the pressurized container outlet area 2210 and/or the dispensing area 2212. In this example, the material utilized to pressurizes the pressurized container 2202 does not mix with the elements in the inside the pressurized container outlet tube 2208, the outside the pressurized container outlet area 2210 and/or the dispensing area 2212.

In FIG. 23, an illustration of a pressurized container is shown, according to one embodiment. In one example, a dispensing device 2300 may include the pressurized container 2202, the bag of ingredients 2204 (and/or pouch and/or any other containment apparatus), the pressure source 2206 (e.g., air, water, any gas (e.g., nitrogen, CO₂, etc.) and/or any other pressurizing substance), the inside the pressurized container outlet tube 2208, the outside the pressurized container outlet area 2210, and a dispensing area 2304. In this example, the pressurized source 2206 applies pressure to pressurize the pressurized container 2202. When the pressure reaches a threshold pressure the bag of ingredients expels one or more elements into the inside the pressurized container outlet tube 2208 which then travels to the outside the pressurized container outlet area 2210 and/or the dispensing area 2304. In this example, the material utilized to pressurize the pressurized container 2202 does mix with the elements in the inside the pressurized container outlet tube 2208 via a mixing pathway 2302, the outside the pressurized container outlet area 2210 and/or the dispensing area 2304.

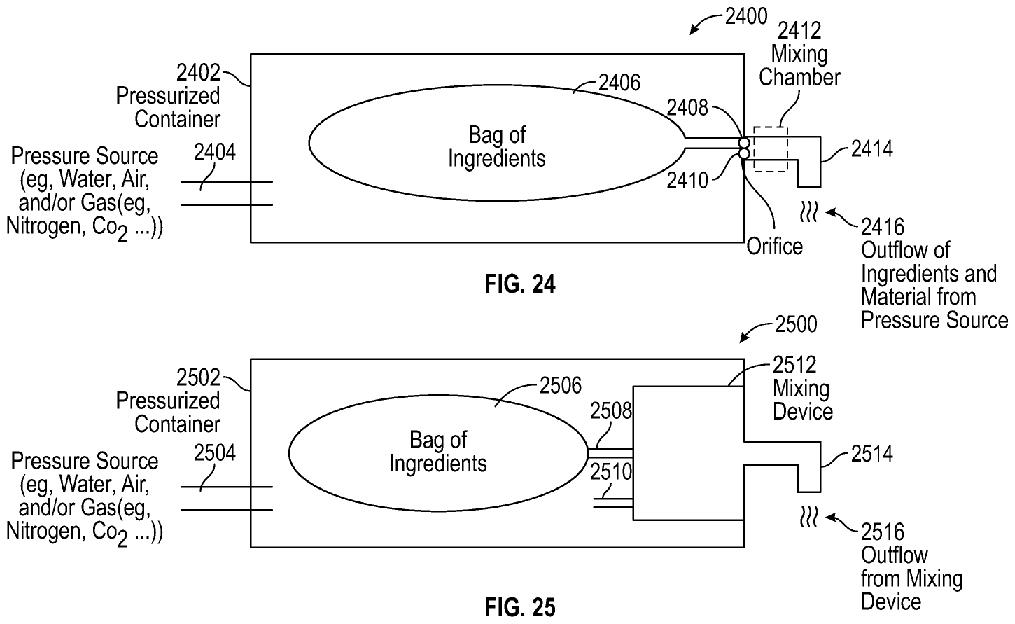

In FIG. 24, an illustration of a pressurized container is shown, according to one embodiment. In one example, a dispensing device 2400 may include a pressurized container 2402, a bag of ingredients 2406 (and/or pouch and/or any other containment apparatus), a pressure source 2404 (e.g., air, water, any gas (e.g., nitrogen, CO₂, etc.) and/or any other pressurizing substance), the inside the pressurized container outlet tube 2208, an outside the pressurized container outlet area 2414, a dispensing area 2416, a bag outlet area 2408, a pressurized container outlet area 2410, and/or a mixing chamber 2412. In this example, the pressurized source 2404 applies pressure to pressurize the pressurized container 2402. When the pressure reaches a threshold pressure the bag of ingredients expels one or more elements into the inside the pressurized container outlet tube 2208 which then travels to the outside the pressurized container outlet area 2414 via the bag outlet area 2408 and then travels into the mixing chamber 2412. In addition, the material utilized to pressurize the pressurized container 2402 travels to the mixing chamber 2412 via a pressurized container outlet area 2410 (e.g., orifice, etc.). The material utilized to pressurize the pressurized container 2402 and the one or more elements from the bag of ingredients 2406 are mixed in the mixing chamber 2412 and dispensed via the pressurized container outlet area 2414 and/or the dispensing area 2416.

In FIG. 25, an illustration of a pressurized container is shown, according to one embodiment. In one example, a dispensing device 2500 may include a pressurized container 2502, a bag of ingredients 2506 (and/or pouch and/or any other containment apparatus), a pressure source 2504 (e.g., air, water, any gas (e.g., nitrogen, CO₂, etc.) and/or any other pressurizing substance), an inside the pressurized container outlet tube 2508, an outside the pressurized container outlet area 2514, a dispensing area 2516, a bag outlet area 2508, a pressurized container outlet area 2510, and/or a mixing chamber 2512. In this example, the pressurized source 2504 applies pressure to pressurize the pressurized container 2502. When the pressure reaches a threshold pressure the bag of ingredients expels one or more elements into the inside the pressurized container outlet tube 2508 which then travels to the mixing chamber 2512. In addition, the material utilized to pressurize the pressurized container 2502 travels to the mixing chamber 2512 via a pressurized container outlet area 2510. The material utilized to pressurize the pressurized container 2502 and the one or more elements from the bag of ingredients 2506 are mixed in the mixing chamber 2512 and dispensed via the pressurized container outlet area 2514 and/or the dispensing area 2516.

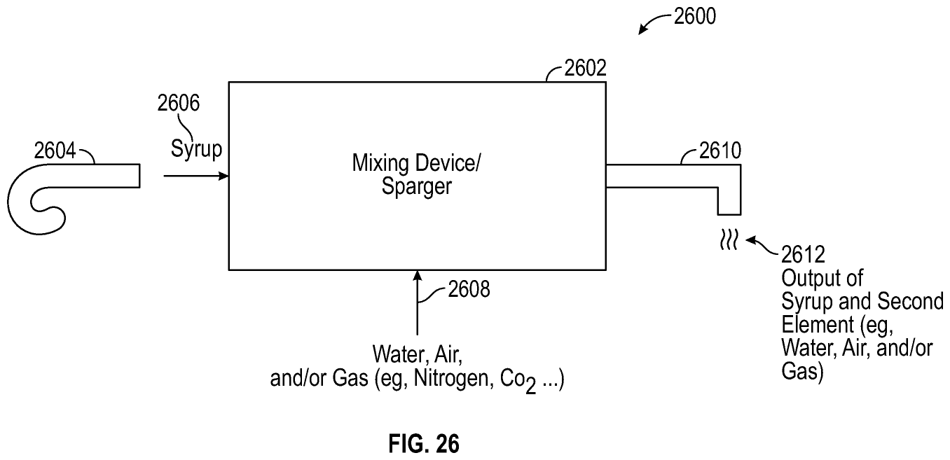

In FIG. 26, an illustration of a pressurized container is shown, according to one embodiment. In this example, a dispensing device 2600 includes a mixing device/sparger 2602, a motor 2604, a syrup flow 2606, a water, air, and/or gas flow 2608, an outlet area 2610 and/or a dispensing area 2612.

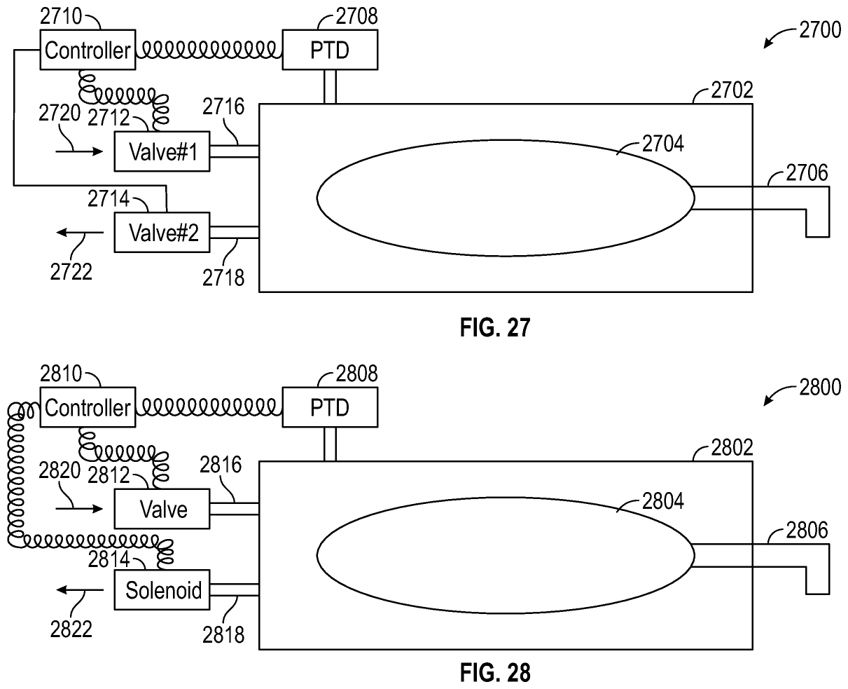

In FIG. 27, an illustration of a pressurized container is shown, according to one embodiment. In one example, a dispensing device 2700 may include a pressurized container 2702, a bag of ingredients 2704, a dispensing area 2706, a pressure transducer 2708, a controller 2710, a first valve 2712 (e.g., CF Valve, CF Valve with solenoid, etc.), a second valve 2714 (e.g., CF Valve, CF Valve with solenoid, etc.), a pressurized container pressure inlet area 2716, a pressurized container pressure outlet area 2718, a first valve inlet area 2720, and a second valve outlet area 2722.

In one example, the PLC controls (e.g., controller 2710) for the dispense canister are based around three functions: the prime cycle, the vent cycle, and the pour cycle. Priming and venting would likely be controlled in the final embodiment with the installation and removal of the lid respectively (reed switch). The pour cycle would be controlled by the request from OCM or manual dispense methods. The system is composed of an inlet CFiVe solenoid valve which pressurizes the canister with compressed air, an exhaust CFiVe solenoid only valve that depressurizes the canister, a dispense valve (no-solenoid) which is controlled by the pressure in the canister, and a pressure transducer (sensor) that informs the controls of the pressurization state of the canister. By using the pressure transducer's output to control the inlet and exhaust valves, tighter control of the opening and closing of the dispense valve, as well as compressed air conservation may be achieved.

An outline of each function is listed below: Prime cycle: Inlet Valve opens; Watch sensor for &quot; Closed&quot; setpoint (rising) &gt; Inlet valve closes when setpoint hit; and Complete. Vent cycle: Exhaust valve opens; Watch sensor for &quot; 0&quot; setpoint (falling); &gt; Exhaust valve closes; and complete. Pour cycle: Inlet Valve opens; Timer activates (shot time); Watch sensor for &quot; Open&quot; setpoint (rising); &gt; Inlet valve closes; and Timer Expires; &gt; Inlet valve closes (if not already); &gt; Exhaust valve opens; Watch sensor for &quot; Closed&quot; setpoint (falling); and complete.

In one example, the pressurize transducer 2708 may indicate a sold-out condition based on one or more sensor readings (e.g., pressure is under a predetermined threshold).

In FIG. 28, an illustration of a pressurized container is shown, according to one embodiment. In one example, a dispensing device 2800 may include a pressurized container 2802, a bag of ingredients 2804, a dispensing area 2806, a pressure transducer 2808, a controller 2810, a valve 2812 (e.g., CF Valve, CF Valve with solenoid, etc.), a solenoid 2814, a pressurized container pressure inlet area 2816, a pressurized container pressure outlet area 2818, a valve inlet area 2820, and a solenoid outlet area 2822.

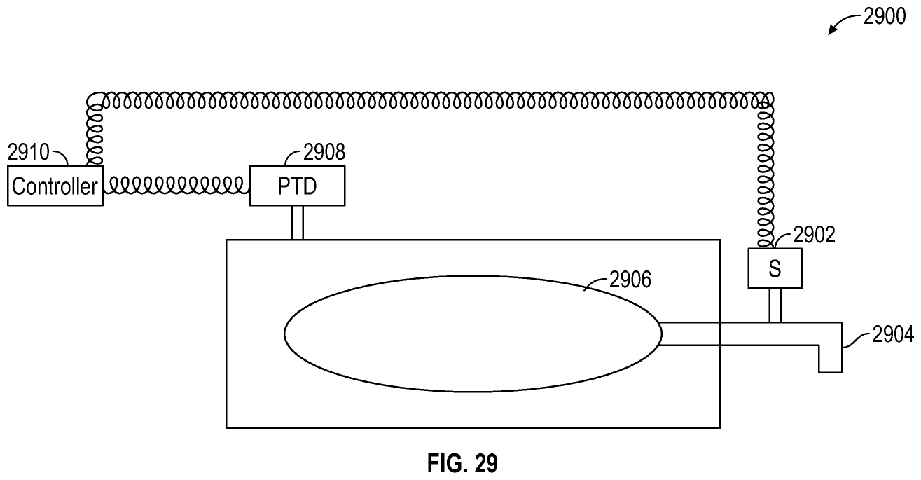

In FIG. 29, an illustration of a pressurized container is shown, according to one embodiment. In various examples, the dispensing device elements shown in FIG. 29 can be utilized with the configurations shown in FIGS. 27-28 and any other dispensing device configuration shown in this disclosure. In this example, a dispensing device 2900 includes a sensor 2902, an outlet area 2904, a pouch of ingredients 2906, a pressure transducer 2908, and/or a controller 2910. In this example, the sensor 2902 can measure flow temperature, humidity, outside temperature, and/or any other data disclosed in this disclosure. Based on the sensor 2902 data being transmitted to the controller 2910, one or more parameters for any device disclosed in FIGS. 27-28 and/or any other device disclosed in any dispensing device in this disclosure may be modified to change the flow rate of the dispensing system and/or any portion thereof.

Existing systems for cleaning beverage, ice cream, ovens and other food equipment are very reliant on labor and efficacy of the cleaning can be impacted by the employee's calculation of dilution factor, remembering/choosing to run the daily, hourly and weekly cleaning cycles. This is subject to serious error and with increased focus on cleaning for quality and safety and with increased awareness by recent global events—restaurants, convenient stores, fast food, institutional purveyors and regulators need better guarantees that equipment is being cleaned appropriately and to the standards require.

Additionally, there is an opportunity for much improved environmental impact and business system impact by providing high and ultra-high ratio concentrates that are diluted on demand reducing package size, shipping size and frequency and dramatically reducing the carbon footprint and costs of delivering cleaning, sanitizing, descaling and other concentrates.

In an existing bucket and pump system measured chemicals are poured into bucket and filled with water to correct level mark on bucket and stir to mix. This bucket is then carried to the front of machine and pump through to sanitize. There are many chances for error in measurement of chemical and/or water in this procedure. Further skin contact of chemicals, carry bucket/spills etc. is problematic. In addition to a ratio control problem, there is a time issue and quality control issues. For example, time between cleaning, as well as time for solution to be present in plumbing to be effective. Furthermore, employee may just skip doing it as it is difficult to do especially in a crowded store. Another issues, is inconsistences on when and how the device is cleaned. For example, a first employee may clean the system at the appropriate time but not at the appropriate ratios. A second employee may not clean the system at all. While, a third employee may clean the system at the appropriate times with the appropriate ratio. In another system, a ChemStation type—fill bucket with chemicals and water each by weight has the same issues noted above. In another example, an Ecolab type may be done by filling a bucket by timed run of peristaltic pump has the same issues noted above. In addition, weekly service to “top off” large storage tank containing a mixed solution—gravity feed to bucket has the same issues noted above.

A Clean in Place method of sanitation that is internal to the machine being cleaned. One or more Ultra High Ratio canisters of concentrated chemical cleaning liquid, may be calibrated to perform the cleaning cycle for a period weeks or months without having to be replaced. The canisters are mounter internal to the machine, plumbed into the machine's water supply source to be cycled on and off as necessary by the machines computer system. When the sealed, single use, canister is empty the machine may stop serving until the empty canister[s] is disconnected at the dry break and is replaced with a new cartridge.

Note the same clean in place system can be situated besides, behind, beneath the machine or even in the back-room of the facility. It can be automatically run by its own controller/computer/timer in the same way the internal-inside machine is run.

One example is a double bag design. The canister may be constructed with a double bag inside a ridged body if there is a chemical compatibility. The interior bag contains the cleaning chemicals and intern is contained in outer bag. The water to supply the pressure and to mix with the solution is fed in between the two bags and expands outward to be contained by the outer ridged body. There is a vent in the ridged body to allow the air to escape as the bag is filled. The benefit of the double bag system is that there is a vacuum between the two bags and there is no change of air being compressed changing the ratio of the concentrate to water mixture.

Another example is a single bag design. The single bag design uses a bag inside a ridged canister. The water supply fills the canister and compresses the bag.

The canister may be assembled with all components built into the cap—check valves, mixing chamber, orifice, etc. This makes for simple assembly and reduced costs (this is different than the current UHR design). Additionally, there may be dry breaks in the canister that allow for a dry/quick connect on the inlet water and the diluted outbound solution. This is an advantage for when the canister is replaced when it is empty. The inlet and outlet dole feature are designed so that it can be placed at any angle to accommodate where it resides in the machine. Dole fittings would allow a universal installation as the supply/discharge would be in any direction.

A system can have single or multiple canisters to allow for different chemicals (i.e.: cleaner, sanitizer, descaler) and also to have multiple different cycles utilizing one or more of the chemicals for varying different lengths of time as needed to clean for different products (i.e.: coffee, milk, juice, ice cream, steam oven, etc.) Multiple canisters would be an advantage because the cleaning for different products [juice or milk] may require a different chemical or a different time to flush.

All of the cycles are controlled either through the controller of the existing equipment or by an external controller/computer built into the CFV-UHR-CIP kit. For example, a smoothie machine may run 4-hour sanitation, daily clean (short) and weekly clean (long) cycles. The built in system will shut down the machine every four hours and run the four-hour cycle, and once a day to run the daily cycle and then once a week for the weekly cycle. The machine will be in operable during the cleaning cycle and will automatically be flushed with clean water after the cycle. Furthermore, there is a Total Dissolved Solids meter and/or sensors that measures the dissolved solids in the city water and then the dissolved solids in the mixed chemical. This will tell the system (whether internal or external) whether the chemical amount is on target and will provide a sold-out feature to notify of chemical replacement. Also, the “sold out” feature can be utilized to shut down the entire machine so there is no way for an employee to allow a “dirty” machine to dispense/cook/mix product.

The canisters can be designed to be single use or recyclable. However, they are designed to be plug and play to the system (again through the dry break connections). The dry break connections are “pokey-oked” so that the operator/employee can NOT connect the inlet to the outlet in error and can NOT connect the wrong chemical cartridge to the wrong inlet/outlet port (i.e.: cleaner to the sanitizer port).

The design of the orifice tube connection to the bag and to the manifold provides a streamline approach that doesn't allow kinking or compression in the canister.

Because the inlet water is controlled by an electronically actuated CFValve it provides a constant pressure and ability to electronically actuate based on time of day and length of desired clean. Furthermore, the addition of the CFiVe for the flush and TDS circuit allows the system to be automatically flushed after use and fore (or force) the TDS sensor to take a baseline water dissolved solids reading to apply the Delta calculation to ensure the proper dilution/strength of the chemical and sold-out feature.

In light of the foregoing, it will now be appreciated by those skilled in the art that the present disclosure embodies a number of significant advantages, the foremost being the automatic pressure responsive control of fluid flow between a variable pressure source and an applicator from which the fluid is to be applied in a substantially uniform manner. The regulating valve is designed for low-cost mass production, having a minimum number of component parts, the majority of which can be precision molded and automatically assembled.

In one example, a regulating valve for maintaining a substantially constant flow of fluid from a variable pressure fluid supply to a fluid outlet includes: a housing having axially aligned inlet and outlet ports adapted to be connected respectively to the fluid supply and the fluid outlet, and a diaphragm chamber interposed between the inlet and outlet ports, the inlet port being separated from the diaphragm chamber by a barrier wall, the barrier wall having a first passageway extending there through from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported exclusively by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring in the cup coacting with the base of the piston assembly for resiliently urging the diaphragm into a closed position against the inner side of the barrier wall to thereby prevent fluid flow from the inlet port via the first passageway into the diaphragm chamber; and the spring being responsive to fluid pressure above a predetermined level applied to the diaphragm via the inlet port and the first passageway by resiliently accommodating movement of the diaphragm away from the inner side of the barrier wall, with the valve head on the stem being correspondingly moved to adjust the size of the control orifice, thereby maintaining a substantially constant flow of fluid from the inlet port through the first and second passageways to the outlet port for delivery to the fluid outlet.

In another example, a regulating valve for controlling the flow of fluid from a variable pressure fluid supply to a fluid outlet includes: a housing having axially aligned inlet and outlet ports adapted to be connected respectively to the fluid supply and the fluid outlet, and a diaphragm chamber interposed between the inlet and outlet ports, the inlet port being separated from the diaphragm chamber by a barrier wall, the barrier wall having a first passageway extending there through from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being supported exclusively by the circular rim and having a peripheral flange overlapping the cylindrical side wall; a piston assembly secured to the center of the diaphragm, the piston assembly having a base projecting into the interior of the cup; a spring in the cup coacting with the base of the piston assembly for resiliently urging the diaphragm into a closed position against the inner side of the barrier wall to thereby prevent fluid flow from the inlet port via the first passageway into the diaphragm chamber; and the spring being responsive to fluid pressure above a predetermined level applied to the diaphragm via the inlet port and the first passageway by resiliently accommodating movement of the diaphragm away from the inner side of the barrier wall, thereby accommodating a flow of fluid from the inlet port through the first and second passageways to the outlet port for delivery to the fluid outlet.

In another example, the control orifice is defined by frusto conical surfaces on the valve head and the outer side of the barrier wall. In another example, the cross-sectional area of the control orifice is less than the cross-sectional area of the first passageway throughout the range of movement of the valve head in response to fluid pressure applied to the diaphragm. In another example, the regulating valve further includes a vent passageway leading from the interior of the cup to the exterior of the housing. In another example, the housing is exteriorly provided with a deflecting surface adjacent to the outlet of the vent passageway, the deflecting surface being configured and arranged to direct fluid escaping from the interior of the cup in the general direction of fluid flowing through the valve, but angularly away from the valve axis. In another example, the base of the piston assembly is spaced from the bottom wall of the cup by an open gap, and wherein the spring means comprises a coiled spring bridging the gap and in contact at its opposite ends with the bottom wall and the base. In another example, the piston assembly is centered within the cup solely by the resilient support provided by the diaphragm. In another example, the housing is comprised of mating plastic inlet and outlet sections, the sections being formed by injection molding and being permanently assembled one to the other by sonic welding. In another example, the cap and base of the piston assembly are each injection molded of plastic and joined one to the other by sonic welding, with a central portion of the diaphragm held there between.

In one example, a dispensing device includes a valve configured to interact with an inlet stream, the inlet stream having a first pressure, the valve having an outlet area with an outlet stream, the outlet stream having a second pressure, and a solenoid which interacts with the outlet stream. In addition, the dispensing device may have: at least one of the inlet stream and the outlet stream being a carbonated water; the first pressure is greater than the second pressure; a size of the solenoid is reduced based on a reduction in pressure from the first pressure to the second pressure; a size of the solenoid is reduced based on the valve; the inlet stream is a utility line; the orifice is fixed; the orifice is adjustable; the orifices are both fixed and adjustable; and the valve is a CF Valve. The CF Valve is a regulating valve for maintaining a substantially constant flow of fluid from a variable pressure fluid supply to a fluid outlet, the CFValve may including one or more of: a) a housing having axially aligned inlet and outlet ports adapted to be connected respectively to the variable fluid supply and the fluid outlet; b) a diaphragm chamber interposed between the inlet and the outlet ports, the inlet port being separated from the diaphragm chamber by a barrier wall, the barrier wall having a first passageway extending there through from an inner side facing the diaphragm chamber to an outer side facing the inlet port; c) a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; d) a resilient disc-shaped diaphragm closing the open mouth of the cup, the diaphragm being axially supported by the circular rim and having a peripheral flange overlapping the cylindrical side wall; e) a piston assembly secured to the center of the diaphragm, the piston assembly having a cap on one side of the diaphragm facing the inner side of the barrier wall, and a base suspended from the opposite side of the diaphragm and projecting into the interior of the cup; f) a stem projecting from the cap through the first passageway in the barrier wall to terminate in a valve head, the valve head and the outer side of the barrier wall being configured to define a control orifice connecting the inlet port to the diaphragm chamber via the first passageway; and g) a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

In another example, the dispensing device may further include: a dispensing unit including one or more flavor units and one or more water units where each of the one or more flavor units include a transportation unit, the transportation unit including a barrier element with one or more openings; a blockage device configured to close the one or more openings to prevent a flow from at least one of the one or more flavor units; and/or a movement device configured to move the blockage device to a first position relative to the one or more openings which allows for a passage of one or more fluid elements and one gaseous elements through the one or more openings in the blockage device.

The dispensing device may further include a carbonated unit. In another example, the movement device is a magnet. In another example, the movement device is an electro-magnet. In another example, the dispensing device may have at least one of the one or more flavor units may be selectable. In addition, the at least one of the one or more flavor units may be automatically selectable.

In one embodiment, the cartridge includes: a body with a first groove and a second groove, the body including a body inlet area and a body outlet area; an O-ring coupled to body via the first groove; a throttle pin coupled to the inlet area; a spring cap with a groove area, a spring cap inlet area, and a spring cap outlet area; a spring cap O-ring coupled to the spring cap via the groove area; a spring coupled to a bottom retainer; a diaphragm coupled to the bottom retainer; and a top retainer coupled to the diaphragm.

In addition, the cartridge may be configured to be inserted into a device. Further, the cartridge may be configured to be inserted into an existing device where the existing device has one or more inlet ports and outlet ports in any locations on the existing device. In addition, a cartridge inlet area and a cartridge outlet area may be in series with each other. Further, a cartridge inlet area and a cartridge outlet area may be at a 90-degree angle to each other (and/or any other angle and/or any other angle disclosed and/or shown in this document). In addition, the body may include a 360-degree outlet passage. Further, the spring cap may be configured to create a seal by compressing the diaphragm to the body. Further, the cartridge may include a CF Valve.

In another embodiment, a movement system includes: a cartridge with a cartridge inlet area and a cartridge outlet area; a housing with a housing inlet area and a housing outlet area; wherein the cartridge transfers at least one or more gases and one or more liquids from the housing inlet area to the housing outlet area independent of a relative position of the cartridge inlet area to the housing inlet area and the cartridge outlet area to the housing outlet area. In addition, the cartridge may include a body with a first groove, a body inlet area, and a body outlet area. In addition, the cartridge may include an O-ring coupled to body via the first groove. Further, the cartridge may include a throttle pin coupled to the inlet area. In addition, the cartridge may include a spring cap with a groove area, a spring cap inlet area, a spring cap outlet area, and a spring cap O-ring coupled to the spring cap via the groove area. Further, the cartridge may include a spring coupled to a bottom retainer. Further, the cartridge may include a diaphragm coupled to the bottom retainer. In addition, the cartridge may include a top retainer coupled to the diaphragm. In addition, the cartridge may include a CF Valve.

In another embodiment, a cartridge includes: a body with a first groove and a second groove, the body including a body inlet area and a body outlet area; an O-ring coupled to body via the first groove; a throttle pin including a pin and a pinhead coupled to the inlet area; a spring cap with a groove area, a spring cap inlet area, and a spring cap outlet area; a spring cap O-ring coupled to the spring cap via the groove area; a spring coupled to a bottom retainer; a diaphragm coupled to the bottom retainer; and a top retainer coupled to the diaphragm. In addition, the at least one of the pin and the pinhead may have a ratio of greater than 1 to the body. Further, the at least one of the pins and the pinhead may have a ratio of less than 1 to the body. In addition, the cartridge may be configured to be inserted into a device. Further, the cartridge may be configured to be inserted into an existing device where the existing device has one or more inlet ports and outlet ports in any locations on the existing device.

In one embodiment, a cleaning system for a drink dispensing device includes: a cleaner canister coupled to a water source; a cleaner CFValve coupled to the water source which provides a first water flow to the cleaner canister. The cleaner canister may provide a cleaner solution to one or more parts of the drink dispensing device.

In another example, the cleaning system may include a sanitizer canister coupled to the water source and a sanitizer CFValve coupled to the water source which provides a second water flow to the sanitizer canister. The sanitizer canister may provide a sanitizer solution to one or more parts of the drink dispensing device. In another example, the cleaning system may include a water flush device coupled to the water source and a water flush CFValve coupled to the water source which provides a third water flow to the one or more parts of the drink dispensing device.

In another example, the cleaning system may include an inlet dry breaking fitting and an outlet dry breaking fitting on the sanitizer canister. In another example, the cleaning system may include an inlet dry breaking fitting and an outlet dry breaking fitting on the cleaner canister. In another example, the cleaning system may include a total dissolved solids device which measures an inlet total dissolved solids and an outlet total dissolved solid. In another example, the cleaning system may include a sanitizer canister coupled to the water source and a sanitizer CFValve coupled to the water source which provides a second water flow to the sanitizer canister. The sanitizer canister may provide a sanitizer solution to one or more parts of the drink dispensing device. A water flush device coupled to the water source and a water flush CFValve coupled to the water source which provides a third water flow to the one or more parts of the drink dispensing device. A total dissolved solids device which measures an inlet total dissolved solids and an outlet total dissolved solids. In another example, the cleaning system may include a sanitizer canister coupled to the water source and a sanitizer CFValve coupled to the water source which provides a second water flow to the sanitizer canister. The sanitizer canister may provide a sanitizer solution to one or more parts of the drink dispensing device; a water flush device coupled to the water source and a water flush CFValve coupled to the water source which provides a third water flow to the one or more parts of the drink dispensing device. A total dissolved solids device which measures an inlet total dissolved solids and an outlet total dissolved solids. An inlet dry breaking fitting and an outlet dry breaking fitting on the sanitizer canister. An inlet dry breaking fitting and an outlet dry breaking fitting on the cleaner canister. A controller that controls one or more ratios based on the inlet total dissolved solids and the outlet total dissolved solids. In another example, one or more of the cleaner CFValve, the sanitizer CFValve, and the water flush CFValve may maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice. In another example, one or more of the cleaner CFValve, the sanitizer CFValve, and the water flush CFValve is configured to maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

In another embodiment, a cap for a canister may include: a CFValve coupled to a cleaning solution source; a tube coupled to the CFValve to transport a cleaning solution; and a tube outlet area to deliver the cleaning solution.

In another example, the tube has a first length and the delivered cleaning solution has a first cleaning solution concentration based on the first length. In another example, the tube has a second length and the delivered cleaning solution has a second cleaning solution concentration based on the second length. In another example, a second tube that has a second length and the delivered cleaning solution has a second cleaning solution concentration based on the second length and wherein the tube has a first length and the delivered cleaning solution has a first cleaning solution concentration based on the first length and wherein the first cleaning solution concentration is different than the second cleaning solution concentration.

In another embodiment, a canister may include: a body with an inlet and an outlet; a cap including a mixing chamber, one or more orifices, and one or more check valves; the inlet coupled to the cap, a CFValve, and a first total dissolved solids sensor; and the outlet coupled to the cap and a second total dissolved solids sensor, the outlet may deliver a flow from the canister.

In another example, the flow from the canister is modified based on data delivered to a controller from at least one of the first total dissolved solids sensor and the second total dissolved solids sensor. In another example, the canister may include a tube with a first length from the CFValve to the outlet where a concentrate of the flow is determined by the first length. In another example, the CFValve may maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice. In another example, the CFValve is configured to maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

In another example, the canister may be coupled to a drink dispensing system for one or more cleaning procedures.

In one embodiment, a dispensing system may include: a pressure vessel with an inlet and an outlet; a first CF Valve coupled to the inlet; a second CF Valve coupled to the outlet; a bag with elements in the bag coupled to the outlet and located inside the pressure vessel; and a pressure source coupled to the first CF Valve where the first CF Valve pressurizes the pressure vessel via the pressure source to transport elements in the bag to the second CF Valve via the outlet and the second CF Valve dispenses the elements to a dispensing area.

In another example, the dispensing system may include a temperature sensor which measure temperature data relating to the elements. Further, the dispensing system may include a controller configured to receive the temperature data from the temperature sensor and to modify an element flow based on the temperature data. In addition, the dispensing system may include a first solenoid coupled to the first CF Valve. In another example, the dispensing system may include a second solenoid coupled to the second CF Valve. In another example, the dispensing system may include a third solenoid configured to provide a pressure relief function. In another example, the dispensing system may include a solenoid coupled to the second CF Valve. In another example, the dispensing system may include a lid with teeth attachments and/or bolt attachments. In another example, the dispensing system may include a fitting which couples the bag with the second CF Valve. In another example, the one or more of the first CFValve and the second CFValve is configured to maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice. In another example, the one or more of the first CFValve and the second CFValve is configured to a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice. In another example, the one or more of the first CFValve and the second CFValve includes a diaphragm and a spring. In another example, the dispensing system may include a cleaning source and a cleaning CF Valve configured to clean one or more parts of the dispensing system.

In another embodiment, a dispensing system may include: a plurality of pressure vessels, each pressure vessel including an inlet and an outlet, each pressure vessel including a first CF Valve coupled to the inlet; a second CF Valve coupled to the outlet, a bag with elements in the bag coupled to the outlet and located inside each pressure vessel; and a pressure source coupled to each of the first CF Valve where the first CF Valve pressurizes a corresponding pressure vessel via the pressure source to transport elements in the bag to the corresponding second CF Valve via the outlet and the second CF Valve dispenses the elements to a dispensing area.

In another example, the dispensing system may include one or more buttons where each pressure vessel of the plurality of pressure vessel is engaged via the one or more buttons.

In another embodiment, a dispensing system may include: a cartridge with elements, an inlet and an outlet; a first CF Valve coupled to the inlet; a second CF Valve coupled to the outlet; and a pressure source coupled to the first CF Valve where the first CF Valve pressurizes the cartridge via the pressure source to transport elements in the cartridge to the second CF Valve via the outlet and the second CF Valve dispenses the elements to a dispensing area.

In another example, the dispensing system may include a first solenoid coupled to the first CF Valve and/or a second solenoid coupled to the second CF Valve and/or a third solenoid configured to provide pressure relief.

The dispensing system and/or dispensing devices can be utilized with OJ, juices, dairy products, soft drinks, coffee, beer, wine, seltzer, and/or any components thereof (e.g., hops, alcohol, pulp, cream, flavors, syrups, etc.).

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. Any combination of any element in this disclosure with any other element in this disclosure is hereby disclosed. For example, an element on pages 5-6 can be combined with any element in this document (e.g., an element from pages 23-26).

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. A dispensing system comprising:
a pressure vessel with an inlet and an outlet;
a first valve coupled to the inlet;
a second valve coupled to the outlet;
a bag with elements in the bag coupled to the outlet and located inside the pressure vessel;
a pressure source coupled to the first valve; and
a pressure material entry into the outlet;
wherein the first valve pressurizes the pressure vessel via the pressure source to transport elements in the bag and the pressure material to the second valve via the outlet;
wherein the second valve dispenses the elements to a dispensing area.

2. The dispensing system of claim 1, further comprising a temperature sensor which measure temperature data relating to the elements.

3. The dispensing system of claim 2, further comprising a controller configured to receive the temperature data from the temperature sensor and to modify at least one of an element flow or a pressure material flow based on the temperature data.

4. The dispensing system of claim 1, further comprising a first solenoid coupled to the first valve.

5. The dispensing system of claim 4, further comprising a second solenoid coupled to the second valve.

6. The dispensing system of claim 5, further comprising a third solenoid configured to provide a pressure relief function.

7. The dispensing system of claim 1, further comprising a solenoid coupled to the second valve.

8. The dispensing system of claim 1, further comprising a solenoid configured to provide a pressure relief function.

9. The dispensing system of claim 1, further comprising a lid with teeth attachments.

10. The dispensing system of claim 1, further comprising a lid with bolt attachments.

11. The dispensing system of claim 1, further comprising a fitting which couples the bag with the second valve.

12. The dispensing system of claim 1, wherein one or more of the first valve and the second valve is configured to maintain a relative constant flow of fluid from a variable pressure fluid supply to a fluid outlet, the valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice.

13. The dispensing system of claim 1, wherein one or more of the first valve and the second valve is configured to a relative constant flow of fluid from a variable pressure fluid supply to a fluid outlet, the valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber;
an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

14. The dispensing system of claim 1, wherein one or more of the first valve and the second valve includes a diaphragm and a spring.

15. The dispensing system of claim 1, further comprising a cleaning source and a cleaning valve configured to clean one or more parts of the dispensing system.

16. The dispensing system of claim 1, further comprising a pressure transducer.

17. The dispensing system of claim 16, wherein the pressure transducer is configured to indicate a sold-out condition based on pressure data.

18. The dispensing system of claim 1, further comprising a mixing chamber.

19. The dispensing system of claim 18, wherein the mixing chamber is located external to the pressure vessel.

20. The dispensing system of claim 18, wherein the mixing chamber is located inside the pressure vessel.
